(19) United States
(12) Patent Application Publication
(10) Pub. No.: US 2021/0235918 A1
(43) Pub. Date: Aug. 5, 2021

(54) Brewing Apparatus For French Press Style Coffee

(71) Applicant: Velluto Coffee, LLC, Davis, CA (US)

(72) Inventors: Clayton W. Chen, Davis, CA (US); Kenneth A. Murray, JR., Davis, CA (US)

(73) Assignee: Velluto Coffee, LLC, Davis, CA (US)

(21) Appl. No.: 17/053,038

(22) PCT Filed: May 4, 2018
(86) PCT No.: PCT/US18/31266

§ 371 Date: Nov. 4, 2020

Related U.S. Application Data
(60) Provisional application No. 62/658,426, filed on Apr. 16, 2018.
(60) Provisional application No. 62/501,306, filed on May 4, 2017.

(51) Int. Cl. A47J 31/06; A47J 31/10; A47J 31/44; A47J 31/46; A47J 31/52; A23F 5/26; B01D 35/20; B01D 29/085; B01D 29/01

(52) U.S. Cl. CPC A47J 31/0631; B01D 2201/02; A47J 31/4457; A47J 31/461; A47J 31/468; A47J 31/5251; A47J 31/5255; A47J 31/5253; A23F 5/26; B01D 35/20; B01D 29/085; B01D 29/01; A47J 2203/00; A47J 2202/00; A47J 31/10

(57) ABSTRACT

An apparatus for production of French press style coffee via a process to immerse and steep coffee grounds in heated water in a non-oil-absorbing environment. Filtering a finished beverage from the steeped mixture through a microperforated non-oil-absorbing filter, where microperforations are sized to achieve sediments levels equivalent to or less than that of traditional French press, and filtration rate is enhanced via any combination of vibratory energy, air pressure, and air flow to the brewed mixture. The microperforated filter may be permanent and reusable, or may be disposable. The disposable filter is preferably made from flexible aluminum foil and recyclable. The apparatus and method support modification of filter size, microperforation size, perforation density, air pressure, air flow and vibratory action to vary beverage filtration rate and finished beverage composition.

### THE NAMES OF THE PART IFS TO A JOINT RESEARCH AGREEMENT

Not Applicable.

### INCORPORATION-BY-REFERENCE OF MATERIAL SUBMITTED ON A COMPACT DISC

Not Applicable.

### FIELD

The disclosure relates to the making of brewed beverages. Specifically, the disclosure describes illustrative embodiments of an apparatus and methods for making French-press style coffee. Still further, the disclosure describes illustrative embodiments employing a perforated filter medium.

### BACKGROUND

The following background information may present examples of specific aspects of the prior art (e. g., without limitation, approaches, facts, or common wisdom) that, while expected to be helpful to further educate the reader as to additional aspects of the prior art, is not to be construed as limiting the scope of any embodiments of the invention thereof, to anything stated or implied therein or inferred thereupon. The following discussion describes various aspects of existing coffee brewing approaches and devices, along with a more detailed discussion of the French press style coffee press, to illustrate the limitations, tradeoffs and compromises inherent to those existing approaches.

Methods for making brewed beverages, such as coffee and tea, have existed and evolved for centuries. The origin and history of coffee dates to the 10th century and earlier with many reports and legends surrounding its first use. The native (undomesticated) origin of coffee is thought to have been in Ethiopia.

One of the most basic ways to brew coffee is by the manual “pour-over” method. For a manual pour-over, coffee is made by passing hot water through coffee grounds contained in a filter (most often cone-shaped). The filter allows the water to pass through the coffee grounds to produce a coffee beverage, while the grounds are left behind in the filter. In a pour-over approach, the amount of time that the heated water is in contact with the coffee grounds is limited by how quickly the water passes through the filter, which is a rate primarily dependent on gravity. Since the time is typically only several seconds, the amount of flavor extraction from the coffee grounds is also limited. This time variable can be manipulated slightly by changing the speed of the manual pour, as well as the number of pours, but can be tedious. The speed of the manual pour can also have an impact on the degree to which the coffee grounds are immersed in hot water, but again this is severely limited by the filtration time. An additional key feature of the pour-over, is that the filter is typically made of paper. This paper filter keeps almost all sediment from passing through into the final brewed beverage, but the paper material absorbs various oils from the coffee grounds, causing removal of components from the finished beverage that affect coffee flavor and smoothness. Non-disposable mesh metal filters are available that preserve the oil, but these permanent filters leave increased coffee ground sediment in the brewed beverage and are difficult to clean.

An alternative to the pour-over process, the coffee percolator was a popular coffee-making approach in the 1800's and early to mid-1900's. A coffee percolator is a type of pot used for brewing coffee by continually cycling the boiling or nearly boiling brew mixture through a vertical conduit to exit at the top of a basket of coffee grounds; the heated brew mixture then gravity feeds through the basket of coffee grounds on a repeated basis until the desired coffee strength is reached. Percolators can expose the coffee grounds to higher temperatures than other brewing methods and recirculate already brewed coffee through the grounds. As a result, coffee brewed with a percolator is susceptible to over-extraction and bitterness. Percolation may also boil away some of the volatile compounds in the beans, resulting in a pleasant aroma during brewing, but a less flavorsome cup upon taste. Additionally, percolators can be difficult to clean, requiring removal of the wet grounds from the basket inside the pot. This can be mitigated by use of paper filters or mesh baskets like those used in the pour-over method, but again with the same limitations as listed above. Coffee percolators once enjoyed great popularity but were supplanted in the early 1970s by automatic drip coffee makers.

Currently, there exists a plethora of coffee-brewing devices, machines, and approaches which have been marketed to consumers. For example, the automatic drip coffee maker, which replaced the percolator, has been popular due to its convenience in approximating the manual pour-over process in an automatic manner. However, automatic drip coffee makers are generally known to produce inferior cups of coffee in comparison to the manual pour-over method. One reason for this lower quality brew from a drip system is that most drip coffee makers produce uneven extraction from the bed of coffee grounds—extracting more from where the water drips into the grounds and extracting less from the periphery. Additionally, while the pour-over method provides moderate control over the degree of immersion of grounds in hot water, drip coffee makers typically provide no means for adjustment. As with the pour-over method, automatic drip machines have a filtration rate that is dependent on gravity, do not allow for full immersion of coffee grounds in the hot water, and use disposable paper filters which remove coffee oils (and thus also flavor) or permanent mesh filter baskets which are inconvenient to clean and leave increased sediment.

Another brewing method is the use of home espresso machines, which brew espresso coffee. Home espresso machines have a quick wet time, theoretically reducing bitterness. However, a fine grind quality is critical in espresso machines. Many home grinders cannot produce an optimal grind for a home espresso machine. Additionally, espresso machines depend on skillful tamping of grounds within the brew cup to pull a good shot. Further, home espresso machines require regular disassembly for cleaning and descaling with caustic chemicals.

Coffee brewing technology has further evolved to address the convenience of “just-in-time” granular brewing on a cup-by-cup basis. One of today's popular brewing methods involves the use of single serve pod brewers, such as the KEURIG. Single serve pod brewers use the same process as a drip machine, but the coffee grounds are premeasured and packaged in the single pod. Consequently, the user does not need to manually measure coffee grounds and pour into a coffee basket filter.

Another long-standing and popular coffee brewing method is known as the French press (also called a coffee press, press pot, coffee plunger, Cafeteria, or cafetiere). The French press method was patented by an Italian designer named Atillio Alimani in 1929. Coffee purists praise the virtues of a French press method, claiming that it produces the fullest coffee flavor.

FIG. 1A is an illustration of the traditional prior art French press brewing device. To brew coffee using the existing French press process and brewing device, several steps are employed, as follows:
Step One: Begin heating water for the French press in a separate vessel, such as a kettle.
Step Two: Place coarse coffee grounds within the French Press carafe (preferred ratio of grounds to water of 1:15 by weight, or approximately three tablespoons of coarse ground coffee per cup of water).
Step Three: Once water is sufficiently heated, pour the heated water into the carafe with the coarse coffee grounds and cover.
Step Four: Set a timer for the desired brew time, typically approximately 4 minutes.
Step Five: After one minute has elapsed, remove lid and stir the mixture to ensure all coffee grounds are immersed in the hot water.
Step Six: Replace the lid.
Step Seven: After four minutes have elapsed, slowly press plunger in lid down through the mixture to separate the grounds from the brewed coffee using the screen mesh filter.
Step Eight: Pour completed coffee into a mug or other serving container. (Leaving brewed coffee within French press carafe with grounds may lead to over-extracted and bitter coffee.)
Step Nine: Remove lid and plunger.
Step Ten: Remove left-over pressed coffee grounds from bottom of the carafe using long-handled spoon or utensil.
Step Eleven: Rinse, wash and dry carafe. Disassemble, rinse, wash and dry lid, mesh filter and plunger mechanism.

Despite the many steps associated with the traditional process of producing brewed French press coffee, the French press brewing process is prized for producing a fuller and bolder cup of coffee than drip machines, or even the pour-over process. The French press process inherently captures more of the coffee bean's flavors and essential oils, since the coffee grounds are maximally and uniformly immersed and soaked in the heated water. Additionally, the mixture steeps for a longer, set duration of time to maximize flavor extraction and produce preferred brew properties. For example, French press coffee grounds typically steep for four minutes, while the pour-over, drip and single serve processes steep the coffee grounds for just a few seconds, just long enough for the hot water to pass through the coffee grounds. Another key feature of the French press process is that it uses a metal mesh filter which allows essential oils to pass through into the final beverage, in contrast to a paper filter from the pour-over, drip, or single serve pod process that absorbs these oils. However, in using the traditional metal mesh filter for separation of the grounds from the brewed coffee, the French press process tends to leave more silt at the bottom of the drinkable beverage, which some may find unpleasant.

When using the French press process, the coffee is typically of a coarser grind compared to drip coffee makers. The larger size of the coarse coffee grounds is intended to reduce the passage of coffee silt through the typical mesh filter of the French press and into the final beverage.

Now in greater detail, as illustrated in the flowchart of FIG. 1B, we describe aspects of the traditional French press brewing process from a user experience perspective using a traditional French press brewing container (carafe) and components. For clarification and to avoid confusion with elements of the inventive subject matter, the steps in the traditional French press process have been lettered, rather than using reference numbers. The following is the sequence of steps as experienced by the user for a traditional French press process, as lettered from (a) to (r): (a) Fill pot with water and begin boiling water on stove; (b) place coarse ground coffee into a French press carafe; (c) monitor water temperature with aid of a thermometer; (d) once the water temperature reaches between 200 and 205 degrees Fahrenheit, (e) add the heated water to the carafe; (f) set and start timer for 4 minutes; (g) at an elapsed time of 1 minute, stir brew mixture to break up coffee ground crust; (h) place the lid and plunger assembly on top of French press carafe; (i) after an additional elapsed time of 3 minutes, slowly depress plunger with mesh screen filter to separate coffee grounds from beverage to the bottom of the carafe; (j) pour finished coffee beverage into serving container or cup; (k) drink and enjoy beverage; (l) remove lid, plunger and mesh filter; (m) remove grounds formed into a compressed puck from bottom of carafe using spoon or other utensil; (n) rinse out remaining spent coffee grounds; (o) dispose spent coffee grounds into garbage disposal; (p) wash and rinse carafe; (q) disassemble plunger and mesh filter; (r) wash and rinse lid, plunger and mesh filter.

Having described the plurality of steps associated with the traditional French press brewing process, certain aspects of the process are notable. First, all the steps in the process are manual and require substantial user participation. Next, the French press process by itself creates additional manual requirements. For example, for filtration of the coffee from the brewed mixture, a circular mesh filtering screen attached to the end of a plunger is pressed slowly and evenly downward within the cylindrical French press carafe and through the brewed mixture, pressing the grounds to the bottom of the carafe and separating the spent coffee grounds from the brewed beverage. This mechanical separation causes the coffee grounds to be pressed and held at the bottom of the French press carafe in the form of a puck; the filtered coffee beverage is above the grounds and the filtering screen.

Once separated, all of the filtered coffee beverage should be poured out of the French press carafe and into another vessel (or vessels) as soon as possible. The other vessel typically comprising a cup, mug, thermos, or other serving carafe. There is a tendency for novices to remove a portion of the brewed coffee for immediate consumption, while leaving the remaining portion within the French press carafe for future consumption. Because it is impossible to remove the pressed grounds from the bottom of the French press container while brewed coffee is still present, leaving coffee within the French press carafe will compromise its taste. The brew left in the French press carafe will overextract from the coffee grounds at the bottom of the container, causing the remaining brewed coffee to become bitter. The only available alternative is to pour any remaining coffee into another vessel, but this results in the use of another vessel that will eventually need to be washed.

Additionally, there is an art to the “French press” which suggests that the grounds should not be “over-pressed” as this may also lead to a more bitter cup of coffee. Consequently, the ultimate quality of the brewed beverage will partially depend on the expertise and approach used by the person making the French press coffee.

Once brewing is complete, the traditional French press device will need to be cleaned. During the filtration/separation of the brewed beverage in a traditional French press device, the spent coffee grounds are pressed into a moist, packed “puck” which will tend to adhere to the bottom and sides of the container and may be hard to remove. For cleaning, any remaining liquid in the French press container is first poured off into a sink. Then, the lid of the standard French press, along with the plunger rod and filter disk, is removed. Next, the majority of the puck is dug out using a long-handled spoon, scraping, brushing, water spray, or other removal technique into a waste container. Any remaining grounds still adherent to the inside of the carafe will require additional rinsing in a sink, preferably with a garbage disposal to prevent plugging the drain. The carafe can then be washed. Finally, the lid, plunger rod, and filter disk are disassembled and cleaned, as well.

There are currently many variations on how French press pots are constructed. Examples are listed below. The BODUM CHAMBORD French press is made of glass and stainless-steel materials to ensure there is no tainting of the brewed beverage by plastic components. The KONA French press adds a protective shield around its glass carafe to prevent breakage. The STERLINGPRO French press uses a filter system with double-layer metal screens to minimize the amount of grounds and silt in the brewed coffee. The GROSCHE MADRID premium French press coffee maker also uses two metal filters, but in a different arrangement. The second filter is positioned adjacent to the lid opening through which the coffee is poured into a serving container.

Another variation involves the use of stainless steel rather than glass in the construction of the French press vessel. For example, the FRIELING stainless steel French press has double wall stainless steel construction to improve thermal retention. The BODUM COLUMBIA stainless steel thermal press pot also has double wall construction, but uses a silicone and mesh plunger, rather than metallic, to avoid scratching the interior walls of the French press container.

Other French press devices are designed as mugs for convenience and preparation of lower volume single servings. One example is the BODUM TRAVEL PRESS. The BODUM TRAVEL PRESS has double wall stainless steel construction, as well as a vacuum seal to maintain the heat in the beverage while the outside of the mug remains cool to the touch. Additionally, the BODUM TRAVEL PRESS uses a silicone and mesh filter to reduce sediment in the filtered coffee beverage.

Another alternative, which leverages a “press” approach, is the AEROPRESS coffee and espresso maker. The AEROPRESS is designed to brew between one to three cups at a time, producing espresso or Americano style coffee. The AEROPRESS is made of plastic, which is known to acquire the odor of the brewed coffee over time. To brew a cup of coffee, a paper filter is first placed at the bottom of a mixing chamber. Hot water and coffee grounds are mixed together for approximately ten seconds. A manually-operated plunger having a seal ring is used to compress air within the mixing chamber, forcing the beverage through the bottom paper filter. The paper filter will absorb essential oils and other components contributed by the coffee beans which will decrease the robustness of taste of the brewed coffee in comparison to French press.

One of the newest machines on the market (first batch delivered in March 2018) is the ORENDA machine made by the AUROMA BREWING COMPANY. The ORENDA machine is described in US Patent Application No. 2017-0119195 by AL-Shaibani et al, filed Oct. 24, 2016, entitled “System and Method for Controlling the Brew Process of Coffee Maker.” AL-Shaibani describes a coffee brewing system whose primary feature is a recirculating function for brewing the coffee. The ORENDA provides customizable single-serve coffee with a marketing focus on pour over coffee using a paper filter. ORENDA also promotes French press by means of a permanent perforated filter in the shape of a disc where French press is primarily distinguished from other types of coffee by the increased level of sediment in the finished beverage. The ORENDA circulates the brew mixture in an effort to soak and steep the grounds. This recirculation is analogous to the process used by an older percolator style, except that the recirculation in the ORENDA uses a pump rather than boiling. Although referred to as providing a French press process, testing showed that the ORENDA process leaves a noticeable portion of the coffee grounds completely dry, despite circulation. Consequently, the grounds are not being adequately soaked. A noticeable difference from traditional French press, is that the ORENDA relies on gravity to separate the finished beverage from the brew mixture through the perforated filter rather than a manual press. In order to allow gravity filtration to produce a drinkable beverage in a reasonable timeframe with the Orenda, the diameter of the perforations needs to be sufficiently large to allow water to flow quickly. This leads to what we believe is the major shortcoming of French press style coffee produced by the ORENDA—the larger perforation diameter results in excessive sediment within the finished beverage in comparison to traditional French press. The end product of the ORENDA is an unpleasantly gritty cup of French press style coffee.

Other approaches have been proposed to assist in creating brewed coffee using alternative means. For example, U.S. Patent Application Number 2012/0308688, entitled “Beverage Formation Apparatus and Method Using Vibratory Energy,” by Peterson et al (hereinafter the Peterson disclosure) discloses an apparatus and method for forming beverages using a cartridge and sonic energy. The emphasis in the Peterson disclosure is directed to applying sonic energy for enhanced mixing of liquid with a beverage medium in a cartridge to increase contact between the liquid and the beverage medium, e.g., coffee grounds or cocoa powder. The Peterson disclosure requires the inclusion of a beverage cartridge; Peterson does not address delivering vibratory energy to an immersion chamber to assist in acceleration of the filtration of a finished beverage from a brewed mixture. The vibratory action described in the disclosure of Peterson is only applied during the steeping or brewing process to introduce sonic energy into the interior space. Further, the Peterson disclosure proposes application of sonic energy having frequencies between 10 Hz and 200 kHz. The disclosure of Peterson does not consider, nor does it address, how to accelerate passage of a finished beverage through filter materials. The Peterson disclosure does describe sonic excitation of the filter to help certain materials pass through the filter that would otherwise not pass through the filter. The disclosure of Peterson does not address manipulation of the beverage element in close proximity with the filter wall to enhance filtration rate while minimizing sediment transport into the finished beverage.

Considering the limitations of the aforementioned approaches to brewing of coffee, emphasizing the French press method, there exists an unmet need for a novel filter medium and coffee brewing apparatus and method capable of producing: (a) a brewed French press “style” beverage in a timely manner; (b) wherein the brewed beverage has the richness associated with a French press style coffee; (c) wherein the brewed beverage has sediment levels comparable with or less than that of traditional French press coffee; (d) wherein the entire brewing process can be implemented and completed via an automated system requiring minimal steps from the user; and (e) wherein the methods and apparatus allows for simple and convenient cleaning of the brewing apparatus.

### SUMMARY

Embodiments of the inventive subject matter comprise a brewing apparatus, filter and method for producing French press style coffee in a simple, convenient and timely manner. The brewing process according to the inventive subject matter achieves the rich and full taste of French press coffee via: (a) full immersion of the coffee grounds; (b) control of immersion time (typically at least 4 minutes); (c) control of brewing temperature; (d) preservation of coffee oils within the finished beverage; (e) control of sediment levels within the finished beverage; and (f) production of the finished beverage in a reasonable timeframe.

In contrast to using a mechanical filter pressed by a plunger as in a traditional French press, the apparatus disclosed herein may use one or more means to separate the brewed beverage from the brewed mixture, emphasizing the use of a microperforated filter supplemented by vibratory energy and/or air-centric activity, including increased air pressure and air flow.

A major advantage of a microperforated filter is in ease of clean up compared to a traditional mesh filter. In a preferred embodiment, the apparatus uses a disposable microperforated filter to simplify and expedite cleaning of the immersion chamber. In one version, the disposable filter comprises aluminum foil. Aluminum foil is cost-effective and provides filter material that is disposable, recyclable, and will not absorb coffee oils which impart flavor to French press coffee. In another preferred embodiment, the apparatus uses a permanent microperforated filter that is reusable, thereby decreasing environmental impact.

Perforation diameter and perforation density of the filter correlate directly with the amount of sediment passed into the final beverage as well as time necessary for filtration. That is, a larger perforation diameter and higher perforation density results in a faster filtration time, but more sediment in the finished beverage. On the other hand, a smaller perforation diameter with an equivalent perforation density results in less sediment, but a slower filtration time. Empirical testing has demonstrated that a perforation diameter that decreases sediment to a level similar to that of traditional French press coffee results in an inconveniently long filtration time if relying on gravity drainage alone to drive the filtration process. However, increasing the perforation diameter to improve filtration time results in excess sediment.

In order to maintain acceptably low sediment levels, the apparatus leverages a novel microperforated filter medium having a plurality of microperforations dispersed throughout the filter wall to minimize the level of fines, silt and sediment in the finished beverage. Although gravity drainage provides a fundamental force for filtering of the brew mixture through the filter, due to the restrictions to flow caused by the microperforations and relatively limited flow area as compared to standard paper filters and mesh filters, supplementary flow enhancement means are typically necessary. In one embodiment, the supplementary flow enhancement means constitutes both increased air pressure and air flow through the filter. The increased air pressure and air flow is applied to accelerate the flow of the brewed beverage through the filter. Thus, coffee filtration is faster with a reasonable level of sediment. In other embodiments according to the inventive subject matter, a supplementary flow enhancement means constitutes the application of vibratory energy to the brew mixture and filter.

In one instance, the filter includes a plurality of 200-micron diameter microperforations with an average microperforation density of 320 microperforations per square inch. Based on empirical testing by the inventor, a microperforation density of 320 microperforations per square inch produces a coffee beverage with sediment comparable to traditional French Press and provides a reasonable filtration rate if enhanced by vibratory energy, air pressure and air flow. This microperforation density likewise preserves the integrity of the filter material such that it will not tear during use and disposal. The inventive filter disclosed herein is adaptable in design to provide variable operational characteristics by adjusting microperforation diameter in the range between 50 and 250 microns, along with variation of the microperforation density and pattern.

The brewing apparatus, as described in various embodiments, comprises an immersion chamber for receiving a beverage element, e.g., coffee grounds, and a brewing liquid, e.g., hot water. In a preferred embodiment, a non-oil absorbing microperforated filter is located or placed within the immersion chamber. The filter and immersion chamber are sized to contain and process the combined volume of coffee grounds and heated water associated with the desired volume of French press style coffee. The filter microperforations are sized to minimize the passage of sediment into a finished beverage, preferably to sediment levels comparable to or less than a similar volume of traditionally made French press coffee. Due to the small size of the microperforations and the limited distribution of microperforations within the filter medium, the speed of the coffee filtration process degrades when filtration is dependent solely on gravity. To overcome this impediment, one or more means to acceleration filtration may be used. In one embodiment, the filtration of the brew mixture may be accelerated via the use of one or more vibratory elements. In an alternative embodiment, the acceleration may be accomplished via the application of an air pump, providing increased air pressure and/or air flow to the brew mixture during filtration. In yet another embodiment, vibratory energy, air pressure and air flow are combined either concurrently or sequentially.

In an air-centric operational mode, the present invention uses air pressure and air flow to separate the brewed coffee from the spent grounds. An air pump may be connected to the immersion chamber to pressurize the brew mixture and/or provide air flow for filtration of the brewed mixture, essentially pushing the brew mixture through the microperforated filter. In this setting, the immersion chamber 30 must be airtight in order to maintain a pressurized environment during the pressurized filtration process and also to minimize any leakage of air flow. In one embodiment, a sealing element, such as an elastomeric ring, is positioned near the bottom of the immersion chamber and surrounds the filter to minimize air leakage around the outside of the filter during the filtration process, thereby increasing efficiency of the air pressure and air flow. In other versions, the sealing element is placed in closer proximity to a top edge of the microperforated filter. The location of the sealing element helps direct the air pressure and air flow, thereby affecting the filtration process.

In a vibrational mode of operation, various means of applying vibrational energy to the filter and/or brew mixture are employed to speed up filtration rates. Examples of such means include, but are not limited to: vibrational DC motors, piezoelectric elements, ultrasound probes, and vibrating tables. The vibrational energy accelerates gravity-based filtration by displacing coffee grounds that are otherwise obstructing or near-obstructing the microperforations in the filter. In this setting, the immersion chamber need not be airtight.

Fundamentally, the brewing method comprises the steps of mixing a beverage element with heated water; allowing the mixture to steep for a specified time; and then filtering the brewed mixture through a microperforated filter to minimize movement of undesirable elements through the filter medium. The filtration rate may be enhanced by any combination of vibratory energy, air pressure and air flow. The microperforated filter, containing the spent coffee grounds, may be removed and disposed, recycled, or reused as appropriate.

Prior to further discussion of the inventive subject matter, it would be prudent to clarify the terminology to be used in the discussion. In particular, the lexicon in the field of vibration and acoustics can be confusing, as the fields of vibration and sound are different, but closely related. Additionally, layman's terms and professional technical terms may mean different things. Vibration, as defined by the ENCYCLOPEDIA BRITANNICA, is the “periodic back-and-forth motion of the particles of an elastic body or medium, commonly resulting when almost any physical system is displaced from its equilibrium condition and allowed to respond to the forces that tend to restore equilibrium.”

An acoustic wave (also known as a sound wave) is a subtype of vibration. More specifically, it is a type of longitudinal wave (e.g., same direction of vibration as the direction of travel) that propagates by means of compression and decompression. Acoustic waves travel at the speed of sound which depends on the medium, e.g., air or water, through which the waves are passing. In some terminology, a sonic wave refers specifically to an acoustic wave that falls within an audible frequency range such that a human can perceive it as sound, e.g., hear it. While the range varies from person to person, a commonly accepted audible range is 20 Hz to 20 kHz. Infrasonic refers to sound waves with frequencies below that of human hearing (<20 Hz), and ultrasonic refers to sound waves with frequencies above that of human hearing (>20 kHz). Confusingly, in other terminology, the term “sonic”′ is all-inclusive and includes the full ranges of infrasonic, audible, and ultrasonic. Additional terms include a subsonic wave which is a wave or vibration traveling slower than the speed of sound, and a supersonic wave which travels faster than the speed of sound.

For the purposes of the following discussion, the terms “acoustic wave/vibration”, “sound wave/vibration” and “sonic wave/vibration” shall include all frequencies whether audible, infrasonic, or ultrasonic. Additionally, the terms “vibration” and “vibratory” shall include subsonic vibrations and sonic vibrations. The term “mechanical vibration” shall be used interchangeably with “vibration”.

### BRIEF DESCRIPTION OF THE SEVERAL VIEWS OF THE DRAWING

These and other features, aspects and advantages of various embodiments according to the inventive subject matter will become better understood regarding the following description, appended claims, and accompanying drawings where:

FIG. 1A is an illustration of the prior art embodiment of a typical French press brewing apparatus and brewing process;

FIG. 1B is a flow chart illustrating the plurality of actual manual steps as experienced by a user of the traditional French press brewing apparatus and process illustrated in FIG. 1A;

FIG. 1C is a flow chart illustrating the fewer steps as experienced by a user of the French press brewing apparatus and process according to the inventive subject matter;

FIG. 2 is an illustration of an exemplary version of a filter, according to the inventive subject matter.

FIG. 3 is an illustration of a first embodiment of a brewing apparatus incorporating both air and vibratory means for filtration enhancement, according to the inventive subject matter;

FIG. 4 is a block diagram of the control unit and primary components, according to the inventive subject matter;

FIG. 5 is a block diagram of components of the fluid systems, according to the inventive subject matter;

FIG. 6 is a block diagram of vibratory components, according to the inventive subject matter;

FIG. 7 is a block diagram of the sensory components, according to the inventive subject matter;

FIG. 8 is a schematic of components driving a single piezoelectric transducer, according to the inventive subject matter;

FIG. 9 is an illustration of an dual piezoelectric transducer arrangement and operation, according to the inventive subject matter;

FIG. 10A is a perspective view of a conical immersion chamber incorporating spacers, according to the inventive subject matter;

FIG. 10B is a side elevation view of the conical immersion chamber of FIG. 10A;

FIG. 10C is a cross-sectional view along the plane A-A of the conical immersion chamber in FIG. 10B illustrating placement of a filter within the conical immersion chamber, according to the inventive subject matter;

FIG. 11A is a top plan view of the immersion chamber arrangement of FIG. 10A, further including piezoelectric transducers;

FIG. 11B is a side elevation view of the conical immersion chamber of FIG. 11A, according to the inventive subject matter;

FIGS. 12A and 12B are illustrations of the operation of the vibratory conical immersion chamber, from a top plan view and side elevation view, respectively, according to the inventive subject matter;

FIG. 13 is a flowchart illustrating the steps of a first beverage preparation method using vibratory action for enhanced filtration, according to the inventive subject matter; and,

FIG. 14 is a flowchart illustrating the steps of the first beverage preparation method using vibratory action for enhanced filtration and including gas dissipation according to the inventive subject matter.

FIG. 15 is a perspective view of a second embodiment of the brewing apparatus using air pressure and flow as means for enhanced filtration, according to the inventive subject matter;

FIG. 16A is a top perspective view of the air-centric apparatus shown in FIG. 15;

FIG. 16B is a side elevation view of the air-centric apparatus shown in FIG. 15;

FIG. 16C is a top plan view of the air-centric apparatus shown in FIG. 15;

FIG. 16D is a front elevation view of the air-centric apparatus shown in FIG. 15;

FIG. 17 is an enlarged side elevation view of the apparatus shown in FIG. 16D;

FIG. 18A is another perspective view of the apparatus in FIG. 15, with its lid open;

FIG. 18B is a cross-sectional view of the apparatus shown in FIG. 18A;

FIG. 19 is an exploded perspextive view from a first side of the apparatus shown in FIG. 15;

FIG. 20 is an exploded perspective view from a second side of the apparatus shown in FIG. 15;

FIG. 21 is a flowchart illustrating the steps of a second beverage preparation method using air pressure and flow for filtration, according to the inventive subject matter;

FIG. 22 is a flowchart illustrating the steps of the second beverage preparation method in FIG. 21 using air pressure for enhanced filtration and including gas dissipation steps, according to the inventive subject matter;

FIG. 23 is perspective view of a third embodiment of a brewing apparatus equipped with air and vibratory enhancement means, according to the inventive subject matter; and,

FIG. 24 is a cross-sectional view of the apparatus in FIG. 23;

### DETAILED DESCRIPTION

The following figures, wherein like parts are designated by like reference numerals throughout, illustrate example embodiments of a beverage brewer apparatus according to the inventive subject matter. Although the disclosure will describe various illustrative embodiments as shown in the figures, other alternative forms may embody the inventive subject matter. One skilled in the art will additionally appreciate diverse ways to alter the parameters of the embodiments disclosed, such as the size, shape, arrangement, or type of elements or materials, in a manner still in keeping with the spirit and scope of the inventive subject matter. For example, a multiplicity of shapes of an immersion chamber and associated components may be used when implementing the inventive subject matter described herein.

Those skilled in the art will also readily appreciate that the detailed description given herein with respect to these figures is for explanatory purposes, as the invention extends beyond these limited embodiments. For example, it should be appreciated that those skilled in the art will, considering the teachings of this disclosure, recognize a multiplicity of alternate and suitable approaches, depending upon the needs of the application, to implement the functionality of any given detail described herein, beyond the implementation choices in the embodiments described and shown herein. That is, there are numerous modifications and variations associated with the inventive subject matter that are too numerous to be listed but that all fit within the scope of this disclosure. In addition, singular words should be read as plural and vice versa and masculine as feminine and vice versa, where appropriate, and alternative embodiments do not necessarily imply that the two alternative embodiments are mutually exclusive.

It is to be further understood that the inventive subject matter is not limited to the methodology, compounds, materials, manufacturing techniques, uses, and applications, described herein, as these may vary. It is also to be understood that the terminology used herein is used for describing illustrative embodiments and is not intended to limit the scope of the inventive subject matter and embodiments incorporating one or more aspects of the inventive subject matter.

It must be noted that as used herein and in the appended claims, the singular forms “a,” “an,” and “the” include the plural reference unless the context dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of logical “exclusive or” unless the context clearly necessitates otherwise.

Structures described herein are to be understood also to refer to functional equivalents of such structures. Language that may be construed to express approximation should be so understood unless the context clearly dictates otherwise. Unless defined otherwise, all technical and scientific terms used herein have the same meanings as commonly understood by one of ordinary skill in the art to which the inventive subject matter is associated. Preferred methods, techniques, devices, and materials are described, although any methods, techniques, devices, or materials similar or equivalent to those described herein may be used in the practice or testing of various embodiments according to the inventive subject matter.

From reading the present disclosure, other variations and modifications will be apparent to persons skilled in the art. Such variations and modifications may involve equivalent and other features which are already known in the art, and which may be used instead of, or in addition to, features already described herein. Although claims have been formulated in this application to particular combinations of features, it should be understood that the scope of the disclosure of the inventive subject matter also includes any novel element or any novel combination of elements disclosed herein either explicitly or implicitly or any generalization thereof, whether or not it relates to an embodiment according to the inventive subject matter as presently claimed in any claim and whether or not it mitigates any or all of the same technical problems as does the an embodiment of the inventive subject matter.

Elements that are described in the context of separate embodiments may also be provided in combination in a single embodiment. Conversely, various elements, which are, for brevity, described in the context of a single embodiment, may also be provided separately or in any suitable sub-combination. The Applicant hereby gives notice that new claims may be formulated to such elements and/or combinations of such elements during the prosecution of the present Application or of any further Application derived therefrom.

References to “one embodiment, “an embodiment,” “example embodiment,” “various embodiments,” etc., may indicate that the embodiment(s) of the inventive subject matter so described may include a particular element, structure, or characteristic, but not every embodiment necessarily includes the particular element, structure, or characteristic. Further, repeated use of the phrase “in one embodiment,” “in another embodiment,” or “in an exemplary embodiment,” does not necessarily refer to the same embodiment, although they may. Further, use of the term “exemplary” is equivalent to the term, “example,” and is not intended to suggest that an exemplary item is a preferred version or embodiment.

Headings provided herein are for convenience and are not to be taken as limiting the disclosure in any way. The enumerated listing of items does not imply that any or all the items are mutually exclusive, unless expressly specified otherwise. The terms “a”, “an” and “the” mean “one or more”, unless expressly specified otherwise.

Components that are in communication with each other need not be in continuous communication with each other, unless expressly specified otherwise. In addition, components that are in communication with each other may communicate directly or indirectly through one or more intermediaries. A description of an embodiment with several components in communication with each other does not imply that all such components are required. On the contrary, a variety of optional components are described to illustrate the wide variety of possible embodiments of the inventive subject matter. For example, one or more of the sensors described in the disclosure may communicate directly with a control unit or with each other. In addition, all sensors described may not be required to support operation of the apparatus.

As is well known to those skilled in the art, many careful considerations and compromises typically must be made when designing for the optimal manufacture of a commercial implementation of any system, and the embodiments of the inventive subject matter disclosed herein. A commercial implementation in accordance with the spirit and teachings of this disclosure may be configured according to the needs of the particular application, whereby any aspect(s), element(s), feature(s), function(s), result(s), component(s), approach(es), or step(s) of the teachings related to any described embodiment of the inventive subject matter may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or construction materials indicated herein are solely provided as examples of suitable configurations and are not intended to be limiting in any way. Depending on the needs of the particular application, those skilled in the art will readily recognize, considering the following teachings, a multiplicity of suitable alternative implementation details, including sizes and scale.

Some embodiments or portions of embodiments according to the inventive subject matter may be implemented into several types of brewing devices including, without limitation, automatic coffee makers, commercial coffee brewing systems, home coffee brewing systems, spice infusers, tea infusers, and other types of infusion brewing devices.

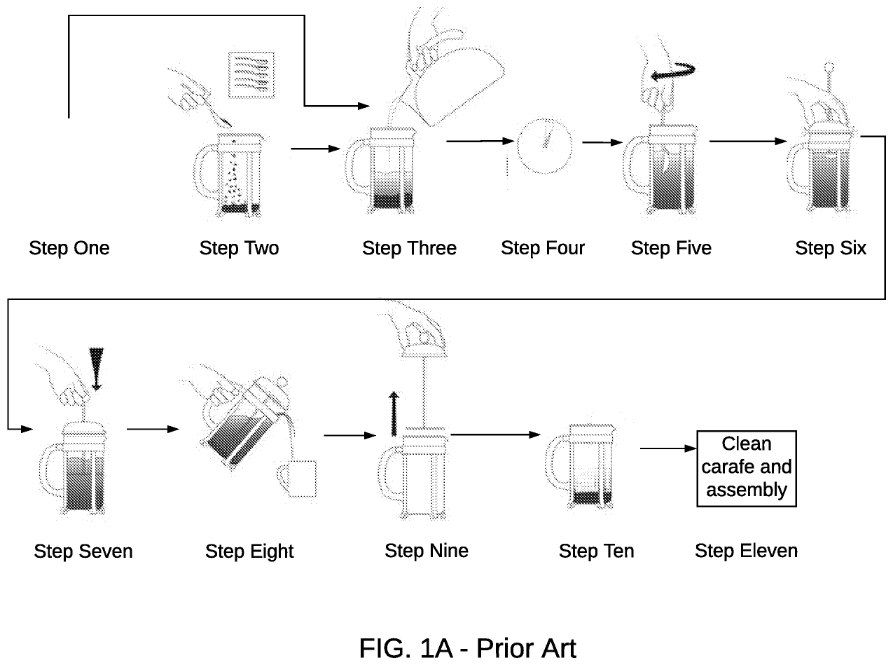

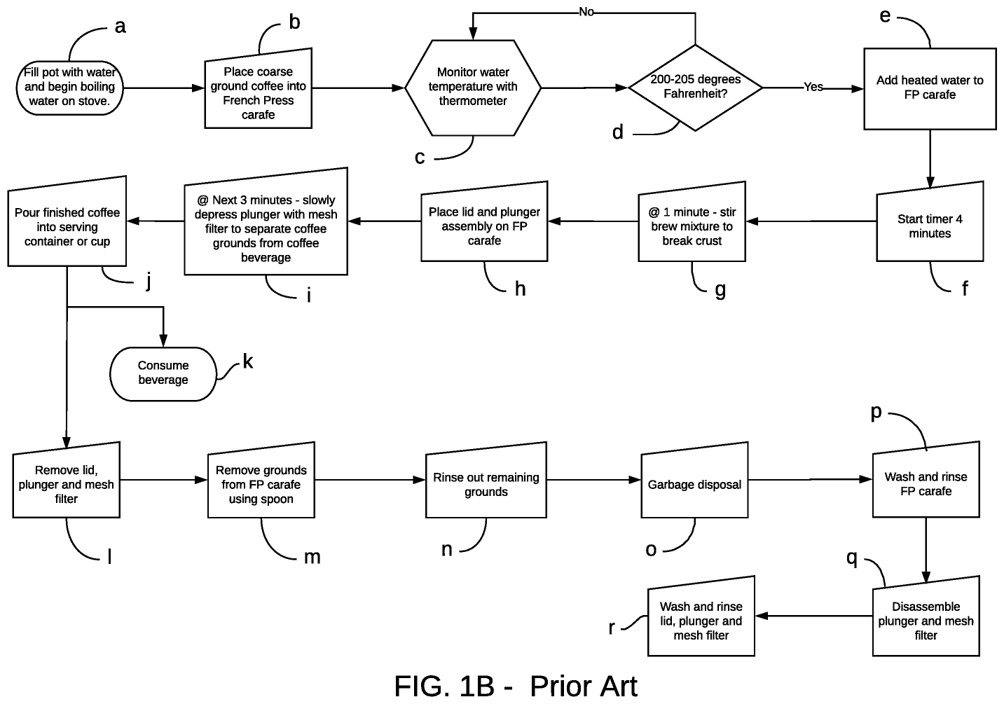

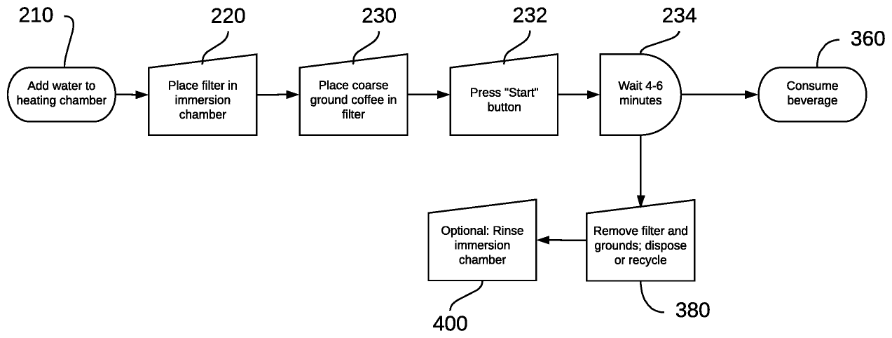

Referring now to FIG. 1C, an illustration of the steps associated with the production of a French press style coffee according to the inventive subject matter is shown. Note that FIG. 1C may be juxtaposed against FIG. 1B, to compare the user experience associated with the many manual steps of traditional French press process against the significantly fewer user steps associated with the process according to the inventive subject matter. The process implemented via the apparatus 10 according to the inventive subject matter begins with step 210, adding water to a heating chamber. Then, in step 220, a microperforated filter 20 is placed in an immersion chamber 30. In alternative embodiments, a permanent microperforated filter component may be physically combined as a portion of the immersion chamber 30. Consequently, a separate filter 20 need not be placed in the immersion chamber 30. Additionally, in other configurations, the filter 20 may be physically separate from the immersion chamber 30. In step 230, coarse coffee grounds are placed into or adjacent to the filter 20. Where the immersion chamber is physically separate from the filter, the grounds are placed within the immersion chamber, with the brew mixture eventually pumped to the filter. Alternatively, as in a “single-use pouch” arrangement, the grounds may come prepackaged within the filter 20 for simultaneous placement within the immersion chamber 30. In step 232, a “Start” button is pushed and the apparatus 10 prepares and filters the brewed mixture to create and dispense a finished French press style beverage into a receptacle. This preparation process, in step 234, will take approximately 4 to 6 minutes. In step 360, the user may consume the finished beverage. In step 380, the user removes the filter 20 containing the spent coffee grounds and may simply dispose or recycle the filter 20 and coffee grounds if using a disposable filter. If a permanent filter has been used, the user needs only to rinse off the filter. In step 400, the user may optionally rinse the immersion chamber 30 in preparation for the next use. Realistically, the user does not need to rinse the immersion chamber after each use.

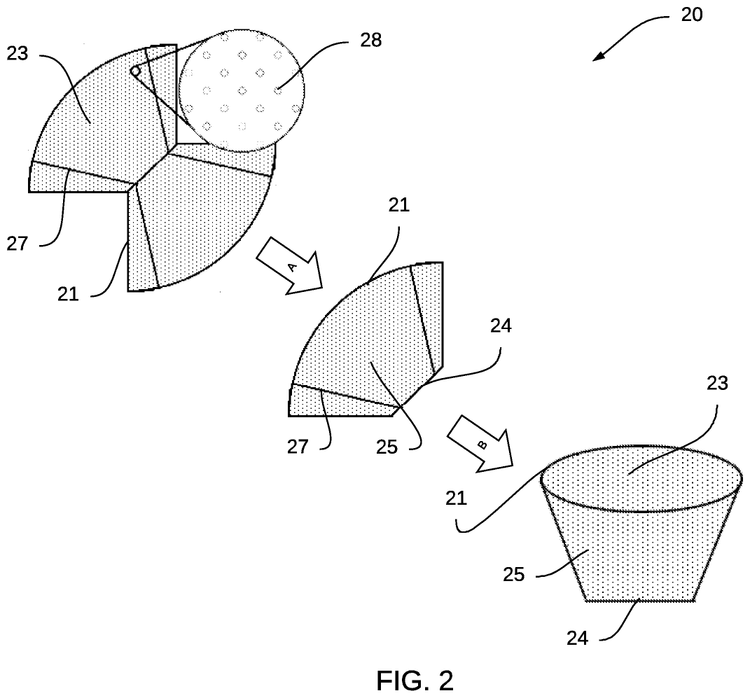

Referring now to FIG. 2, an exemplary approach for creating a disposable filter 20 according to the inventive subject matter is shown. The disposable filter 20 is produced from a metallic film, e.g., aluminum foil. A sheet 21 of the metallic film is penetrated by a plurality of preferably circular microperforations 28. The diameter and density of the microperforations 28 may be adapted to enable timely passage, with assistance of any combination of vibratory energy, air pressure, and air flow, of the finished beverage through the microperforated filter 20, while minimizing the passage of the used beverage element, e.g., coffee grounds, as well as any associated silt, fines or sediment, into the finished beverage. In one configuration, the disposable filter 20 is prepackaged with ground coffee already within the filter material providing a “single-use pouch”.

In yet another embodiment, the microperforated filter 20 is permanent and reusable. The permanent microperforated filter 20 has an advantage over traditional mesh filters with regards to ease of clean up. Mesh filters tend to trap grounds within the filter itself, which makes removal of the grounds and washing of the filter more difficult. In comparison, the microperforated filter 20 according to the present invention has a uniformly flat surface that does not trap grounds as readily. Thus, simply rinsing off the permanent microperforated filter 20 is often sufficient for cleaning, whereas a mesh filter may require scrubbing or brushing.

A filter 20 compromised of aluminum foil will support a plurality of microperforations 28 wherein the microperforations 28 may have diameters between 20 and 500 microns, and a density between 10 and 700 microperforations per square inch. Testing has shown that smaller microperforations 28 less than 250 microns in diameter are preferable to minimize the amount of sediment transported into the finished beverage during filtration. Since these smaller microperforations 28 cause the rate of flow to be reduced during filtration, the present invention leverages vibrational and air-centric means to enhance and accelerate the filtration rate.

Testing has also shown that an embodiment of the brewing apparatus 10 using a filter 20 having circular microperforations 28 of 225 microns in diameter with a density of 320 microperforations per square inch is effective in minimizing sediment transport into the finished beverage, achieving sediment levels comparable to or less than that of an equivalent volume of traditionally brewed French press coffee. However, this filter configuration requires means for flow enhancement to accelerate filtration and produce the finished beverage in a satisfactory amount of time. The size and density of the microperforations 28 may be varied to alter properties of the finished beverage and the time required to filter the finished beverage from the brew mixture. For example, microperforation size may be further decreased to decrease sediment levels. As such, vibrational energy, air pressure and air flow may be increased to compensate for the otherwise increased filtration time.

Based on several types of manufacturing methods available to produce the microperforations 28 in the filter 20, the microperforations 28 will typically be circular. However, the microperforations 28 may be of other shapes including diamond, triangular, oval, oblong, hexagonal, square, slit, rectangular and any other shape that is sized appropriately to prevent passage of grounds and sediment into the finished beverage while allowing adequate filtration flow rate, typically requiring supplementation. Cold needle, hot needle, chemical etching, laser microperforation methods and other methods for perforating the filter medium may be used to create microperforations 28 in the filter 20.

In a preferred embodiment, the filter 20 is made of aluminum foil and is disposable. The aluminum foil used for the filter 20 will preferably have a thickness typical to that of standard household aluminum foil, e.g., between 0.5 and 1.2 mils. A mil is a measurement that equals one-thousandth of an inch, or 0.001 inch. A thickness of 0.7 mils was found to be suitable for a disposable filter 20 for use with the brewing apparatus 10, as it balanced pliability and structural strength. Other thicknesses may be used to modify the properties of the filter 20, e.g., to accommodate different sizes and shapes of the immersion chamber 30, different filter sizes and shapes, different filter manufacturing methods, reusability, different filter microperforation sizes/densities and the cost of filter production.

The demonstrated shape in the preferred embodiment is conical, but other shapes including baskets, cylinders, discs and other custom shapes are possible. An advantage of the conical shape over a disc shape is increased surface area for placement of microperforations 28, which increases the cross-sectional flow area available for filtration and thus decreases filtration time. Additionally, in an air-centric approach, the spent coffee grounds tend to collect on the interior walls 23 of the filter 20 in addition to the bottom 24 of the filter 20. This effectively removes grounds, including unwanted sediment, from the brew mixture as the brew mixture volume drops during filtration, thereby decreasing the amount of unwanted sediment that is potentially available to pass through the filter 20 and into the finished filtered beverage. In comparison, where the filtration process is enhanced by vibration, the spent grounds tend to collect mainly at the bottom 24 of the filter 20, forming a packed cake. Due to the vibratory action, the cake is much more dense than the cake formed with a gravity alone mechanism or an air-centric mechanism. The packed cake further acts as a supplemental filter medium to help decrease sediment passage through the filter 20 into the finished beverage.

The filter 20 may be made from other materials and may be disposable or non-disposable, e.g. permanent and reusable. Materials for either the disposable or permanent filter 20 are preferably inert and relatively non-reactive with acids produced in the brewed coffee. Additionally, the material should not absorb oils produced during the brewing process. Typically, those who prefer the result of the French press brew method contend that the oils lend additional flavor and robustness to the final brewed beverage. Examples of other material which may be used to form the filter 20 include, but are not limited to: stainless steel and other metals, metallized films, nylon, other inert synthetic polymers, polyesters, pliable films which do not interact with the acids in the coffee, silicone, plastic, bamboo and other non-oil absorbing cellulosic material which can be processed and manufactured to create the desired filter shape with the appropriately sized microperforations, either singly or in combination with other materials.

In one instance, the filter 20 may comprise two or more layers of the aforementioned materials, wherein each layer may perform one or more functions. For example, if appropriate to change the properties of the brewed beverage to suit consumer tastes, an oil-absorbing layer may be applied to the interior surface 23 of the aluminum microperforated filter 20 to create an arrangement where French press style coffee may be enjoyed with minimal silt and fines, and properties of the oil-absorbing layer could be controlled to customize the level of oil absorption according to a coffee drinker's preference.

In construction, a filter 20 may be comprised of a single sheet 21 or two or more sheets 21 of material. Further, the filter 20 may incorporate reinforcing components such as cotton or polyester thread to provide additional strength. The thread may be applied in a web within the aluminum foil to enhance reinforcement of the aluminum foil while avoiding negatively impacting its favorable qualities, such as conformability to the shape of the immersion chamber 30 and avoidance of absorption of desirable oils.

In another configuration, the aluminum foil used for the filter 20 may comprise two layers sandwiching an extensible film or other layer to produce greater strength via mutual reinforcement. In such a sandwiched configuration, aluminum foil bonded to an extensible plastic film or other layer will allow the foil to stretch further than just foil alone. In addition, with the plastic film or other layer sandwiched between two layers of aluminum foil, the only exposure of the brewed beverage to the plastic film will occur at edges of the interior perimeter of the microperforations 28, thereby lowering the potential for the plastic film to negatively impact the flavor of the brewed beverage. In another configuration, the filter 20 may comprise a plastic film including a threaded web portion laminated between two or more layers of aluminum foil. In an additional configuration, the filter 20 may be comprised of two or more laminated sheets of aluminum foil.

Testing indicates that desirable sediment levels and a reasonable filtration rate may be obtained using a filter 20 having 225-micron diameter microperforations 28 and a density of 320 microperforations per square inch. These filter parameters were testing using one vibratory element 50 comprising a 12V vibrating DC motor operated at 6V and placed on the side of the immersion chamber wall 31. This configuration filters the finished brewed beverage from the brewed mixture in a reasonable time (90 seconds for eight cups of coffee) and with an acceptable level of sediment (1.8 grams). The test results were based on the use of 84 grams of coarse ground Pete's Coffee French Roast and 5.3 imperial cups of water, with a single stir of the brew mixture at one minute into the steep. As a comparison, the same ratio of grounds to water in a traditional French Press carafe produced approximately 2.0 grams of sediment. Note that testing has shown that the flow rate through the filter 20 will vary as the finished beverage is displaced through the microperforated filter 20 and into the dispensing region 34 due to a reduction in hydrostatic pressure caused by a reduction in the height of the fluid in the immersion chamber 30. This reduction in flow rate may be partially offset by an increase in vibratory energy delivered via one or more vibratory elements 50.

In other testing, a WAHL Hot Cold Therapy Massager was held on top of the lid 32 of the immersion chamber 30 to induce vibratory action in the wall 31 of the immersion chamber 30. Various vibratory intensities were used to measure the enhancement of the filtration process. This testing provided confirmation that the application of vibratory action would improve the rate of filtration of the brewed beverage in the present invention. Since the lid-based vibratory element 54 was held on the top of the lid 32, the bulk of the energy delivered was infrasonic in nature, causing the wall 31 of the immersion chamber 30 and the brew mixture to primarily vibrate mechanically.

In another test configuration, an UXCELL Black DC 12V 3100 RPM vibration motor designed for a massage cushion was epoxied to the external wall 35 of the immersion chamber 30 near the bottom portion of the immersion chamber 30. Once again, this testing confirmed that placement and operation of a vibratory element 50 on the wall 31 of the immersion chamber 30 would also improve the rate of filtration of the brewed beverage. In an additional test configuration, two vibration motors from PRECISION MICRODRIVES from the UNIVIBE line having eccentric weights were tested. These vibration motors used a rated operating voltage of 3V. A first motor, Model 312-107 (the “107” motor) has a rated vibration speed of 6600 RPM with a typical operating current of 250 milliamps and a normal amplitude of 14.3 G. A second motor, Model 320-102 (the “102” motor) was also tested. The 102 motor has an operating voltage of 3V, an operating current of 470 milliamps, a rated vibration speed of 7700 RPM and a normal amplitude of 17 G. Operating characteristics of these motors can be manipulated by changing the input voltage, with the UNIVIBE line having well documented performance curves as a function of voltage. Once again, this testing confirmed that placement and operation of a vibratory element 50 on the wall 31 of the immersion chamber 30 would improve the rate of filtration of the brewed beverage. Additionally, filtration performance can be manipulated by altering the voltage input for the vibratory motors.

The testing confirmed that different operational modalities may be implemented to (a) tune the operation of various vibratory elements 50, 51, 52, 54, 56, 1610, 1612, 1650 and a vibrating table, (b) adapt the filtration process to the differing operational modalities and motion of various vibratory motors, and (c) to accommodate attachment of various vibratory elements 50, 51, 52, 54, 56, 1610, 1612, 1650 and a vibrating table to differing locations and surfaces associated with the immersion chamber 30. For the sake of convenience, this disclosure will use the reference number 50 to refer to all potential vibratory elements, positions, and arrays 51, 52, 54, 56, 1610, 1612, 1650 and a vibrating table unless, otherwise specified.

Additionally, it was observed during testing that various motor speeds can cause the vibratory motor to oscillate back and forth. Additionally, higher voltages applied to a vibratory motor can cause erratic and more pronounced vibration. The control unit 90 may be programmed and configured to support the appropriate operational requirements of one or more types of vibratory motors to minimize erratic and noisy operation.

Based on the various test scenarios, the control unit 90, in association with logical instructions 92, e.g., via software, provides flexible operation to accommodate testing of various vibratory motors under actual operational conditions with attachment to the immersion chamber 30 to identify and select one or more preferred operational parameters. Selected operational parameters preferably provide an optimization and balance between rate of beverage filtration from the brewed mixture through the filter 20 versus the amount of silt, fines and sediment that may pass through the filter microperforations 28 into the final finished beverage. The control unit 90 will support variable operational parameters to accommodate properties of the type of material used to form the wall 31 of the immersion chamber 30 and the filter 20. In addition, the control unit 90 will support modification of operational parameters driven by the configuration of the filter 20, the selection of types of coffee grounds, including the coarseness of the grind and the preferred outcome for the coffee drinker regarding taste and body.

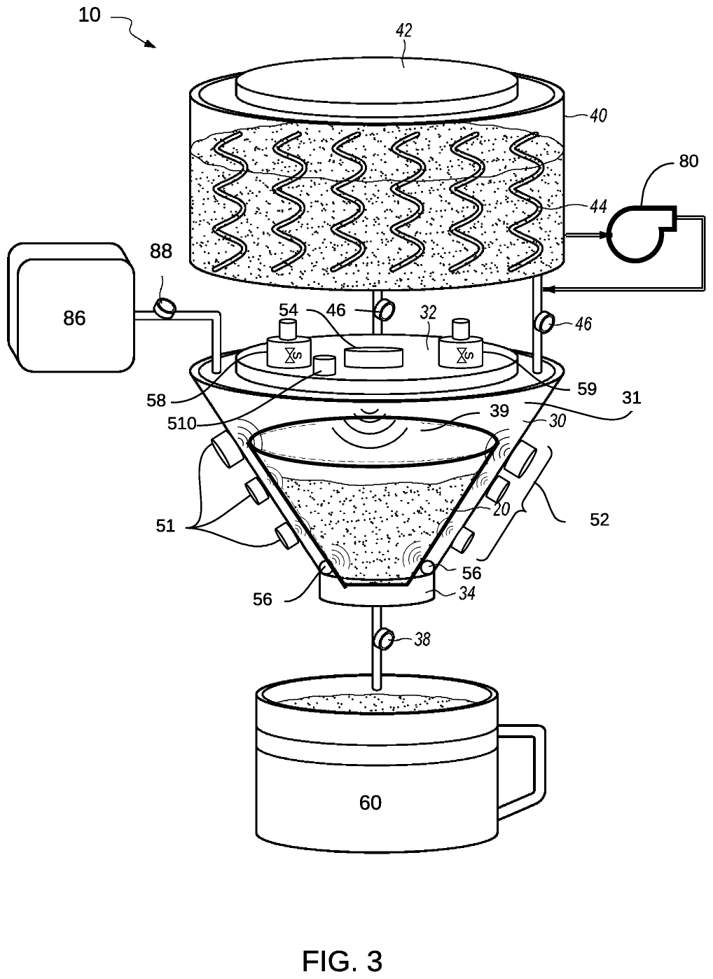

Referring now to FIG. 3, a first embodiment 10 of a brewing apparatus according to the inventive subject matter is shown. As illustrated, this first embodiment incorporates both vibratory and air-centric means for accelerating filtration. One skilled in the art will recognize that the first embodiment 10 may be redesigned to package the various components in a more consumer friendly arrangement and housing. The first embodiment 10 comprises an immersion chamber 30 having one or more vibratory elements 50 and an air pump 86, providing two separate or combinable means for accelerating the filtration process. The immersion chamber 30 is sized to receive and house a separate, disposable microperforated aluminum foil filter 20. In an alternative configuration, a perforated permanent filter 20 may be used.

The first embodiment 10 of the brewing apparatus further includes a water heating chamber 40 and a water chamber lid 42. One or more electrical heating elements 44 may be located within or adjacent the heating chamber 40. The heating elements 44 heat the water within the heating chamber 40 to a desired temperature, before the heated water is transferred into the immersion chamber 30. One or more water transfer valves 46 open to allow the transfer of heated water from the heating chamber 40 to the immersion chamber 30. The placement of the heating chamber 40 is flexible. In FIG. 3, the heating chamber 40 is shown positioned above the immersion chamber 30, where water delivery to the immersion chamber 30 may be accomplished via gravity feed. Alternatively, the heating chamber 40 may be placed alongside the immersion chamber 30 where a water pump 80 is used to transfer heated water into the immersion chamber 30.

In one embodiment, the immersion chamber 30 is sized to hold the full desired volume of heated water. This configuration maximizes extraction of desirable elements from the coffee grounds by the heated water and most closely approximates traditionally brewed French press coffee. Alternatively, the immersion chamber 30 may be sized smaller than the full desired volume to reduce the overall size of the apparatus. in order to save on size, but with the tradeoff that extraction may not be as complete as for the full immersion volume. As an example, if eight cups of heated water are planned to immerse for a total of four minutes, and the immersion chamber 30 is sized for only six cups, the additional two cups of heated water may be added to the immersion chamber 30 as space is made during filtration or perhaps directly dispensed into the receiving carafe 60. These two additional cups will not have the same amount of time to steep, thus resulting in weaker coffee. The addition of these final two cups of coffee or heated water to the initial six cups of coffee dilutes the strength of the initial six cups. This can be compensated for partially by using more coffee grounds; however, for some drinkers, this may be a desirable outcome, creating a coffee hybrid between French press and automatic drip.

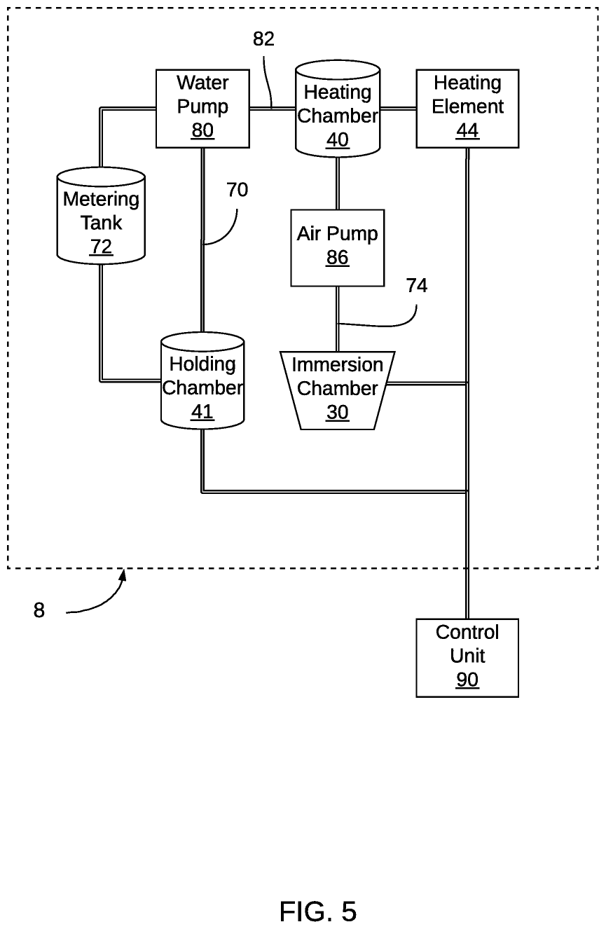

In an alternative version, the brewing apparatus 10 may include a holding chamber 41 and a metering tank 72 (see FIG. 5). This configuration provides a separate arrangement where the heating chamber 40 is only used to heat a desired volume of water. In another version, one or more water nozzles (not shown) may be distributed about the periphery of the immersion chamber 30 and directed to dispense heated water into the interior 39 of the immersion chamber 30 to enhance mixing of the heated water and beverage element, e.g., coffee grounds. In another version, the water may be heated directly as it is pumped into the immersion chamber 30, rather than heating all the water at once or in a batch mode, prior to transfer into the immersion chamber 30.

As shown in FIG. 3, the immersion chamber 30 may be conically-shaped. However the design of the first embodiment 10 of the brewing apparatus may be configured to support a multiplicity of immersion chamber shapes and sizes. The immersion chamber 30 may include a lid 32 which is opened to insert or remove the filter 20 and coffee grounds. During the brewing process, the lid 32 is preferably closed. The immersion chamber 30 includes a dispensing valve 38 below a dispensing region 34 positioned at the bottom of the immersion chamber 30.

As shown in the illustration of the embodiment 10 of the brewing apparatus in FIG. 3, the vibratory elements 50 are affixed to the immersion chamber 30. The vibratory elements 50 may be placed at one or more locations on the immersion chamber 30. In one embodiment, a single vibratory element 54 may be attached to the lid 32 of the immersion chamber 30. In another embodiment, a single vibratory element 56 may be positioned adjacent the bottom of the immersion chamber 30. In yet another configuration, the brew mixture may be agitated via a vibratory probe 1650 inserted into the immersion chamber 30 down through the brew mixture.

The dispensing valve 38 controls the flow of the finished beverage from the dispensing region 34 to a receiving receptacle 60, e.g., a cup or carafe. In an alternative version, the dispensing region 34 may be sized to hold the entire volume of the finished beverage before dispensing into a receiver 60. Alternatively, the immersion chamber 30 is operable without a dispensing region 38, where the finished beverage is dispensed directly into a receptacle 60, e.g., a cup, carafe, thermos and other similar receptacles suitable for holding a hot beverage. The dispensing valve 38 may be manually controlled, electronically controlled, or designed to automatically and mechanically open after a specified time or trigger. The dispensing valve 38 may comprise an electric solenoid valve. One or more vibratory elements 50 deployed in one or more arrays 52 transmit vibratory energy into the wall 31 of the immersion chamber 30 and into the brew mixture during the filtration process to accelerate passage of the finished beverage through the microperforated aluminum foil filter 20.

In one version of the vibratory mode implementation, the vibratory energy from the vibratory elements 50 is disorganized, wherein the vibratory elements 50 transmit energy into the filter 20 and brew mixture, such that the filter wall 21 and brew mixture move in relation to each other, causing coffee grounds to move off microperforations 28 to expose more flow area during filtration of the brewed beverage from the brewed mixture, thereby accelerating the filtration rate.

In another embodiment, the vibratory energy from the vibratory elements 50 is organized such that one or more standing waves is created. In that embodiment, the vibratory energy from vibratory elements 50 is transmitted into the brew mixture along radially aligned directions, generally perpendicular to the tangent associated with the curvature of the wall 31 of the immersion chamber 30. The vibratory elements 50 transmit energy to through the immersion chamber 30 and the filter 20 and brew mixture, such that the filter wall 21 and brew mixture move in relation to each other, causing coffee grounds to move off microperforations 28 to expose more flow area during filtration of the brewed beverage from the brewed mixture, thereby accelerating the filtration rate. The creation of standing waves, in one instance, enhances the entrapment of coffee grounds and sediment within the middle interior of the filter 20, decreasing sediment passage through the microperforations 28 and into the finished beverage.

The vibratory elements 50 are spaced and interspersed about the perimeter of the immersion chamber 30. Each vibratory element 50 may operate in synchronization with other vibratory elements 50 or independently to transmit vibratory energy to the brew mixture. In higher frequency operation, the vibratory elements 50 are preferably spaced more closely together. In lower frequency operation, the vibratory elements are preferably spaced farther apart. A plurality of the vibratory elements 50 may be affixed to the wall 31 of the immersion chamber 30 by means for engagement that ensure transmission of the vibratory energy into the wall 31 of the immersion chamber 30. The wall 31 then serves as a vibratory diaphragm or transmission means for transmitting vibratory energy emanating from the vibratory elements 50 through the immersion chamber 30 and filter wall 21 and into the brew mixture. The vibratory energy enhances the filtration rate of the finished beverage and degassing of the brew mixture during the bloom and steeping phases of the brew process.

The immersion chamber 30 is manufactured such that the material in the wall 31 is of an appropriate thickness to optimize the transmission of sonic energy from one or more vibratory elements 50. In operation with the standing wave, the energy emitted by a plurality of vibratory elements 50 distributed about the perimeter of the immersion chamber 30 creates an energy field within the brew mixture such that particles within the brew mixture tend to stay and aggregate within the center portion of the immersion chamber 30. The vibratory elements 50 transmit sufficient sonic energy such that particles, such as silt and fines, tend to aggregate in a more centralized portion of the immersion chamber 30, minimizing the likelihood of transport through the microperforations 28.

The vibratory elements 50 are driven by a power supply 91 which is connected via power cables 94. The power supply 91 is operated and controlled via the control unit 90. The control unit 90 is tunable and includes operational intelligence to allow frequencies emanated from the vibratory elements 50 to be selected to support a balance between a desired rate of filtration and a desired level of fines, silt or sediment drawn through the microperforations 28.

The control unit 90 includes operational logic and intelligence to adaptively operate an adjustable dispensing valve 38, wherein the rate of filtration may be controlled by adjustment of the flow rate through the dispensing valve 38. Based on this control, fines, silt and sediment are less likely to be carried through the microperforations 28 and into the finished beverage. In one operational configuration, the control unit 90 manages application of a sonic energy field to the beverage mixture such that the coffee grounds, silt, fines and sediment tend to aggregate in the center of the brewed beverage during filtration. This aggregation facilitates and enhances filtration of the brewed beverage through the filter 20.

The vibratory elements 50 may comprise an array 52 of individual vibratory elements 51 configured for distribution and attachment to the wall 31 of the immersion chamber 30. Where an array 52 is configured to wrap about the immersion chamber 30, the control unit 90 may control which vibratory elements 51 are activated and which are dormant during the filtration process. For example, the control unit 90 will cease operation of vibratory elements 50 positioned above the fluid level in the immersion chamber 30.

In another configuration, the dispensing valve 38 may include an extension (not shown) in the shape of a gooseneck extending laterally from the bottom of the dispensing valve 38. The extension may include a screened filter element placed downstream from the dispensing valve 38 wherein the mesh within the filter element is sufficiently small to prevent any additional fines or silt from overflowing into the beverage receptacle 60. The gooseneck extension may be configured to disconnect from the bottom of the dispensing valve 38 to allow it to be easily cleaned by simply rinsing under a faucet. In a vibratory filtration mode, the interior 39 of the immersion chamber 30 is in communication with the external atmosphere to ensure that a negative pressure is not created within the immersion chamber 30 when the finished beverage is being dispensed. A negative pressure differential would prevent or impede filtration of the brewed beverage. In the vibratory mode, at the outset of the filtration and dispensing of the brewed beverage, the vibratory elements 50 induce vibratory forces into the wall 31 of the immersion chamber 30 and into the brew mixture to assist in acceleration and separation of the brewed beverage from the brew mixture.

Application of vibratory energy at various frequencies produces several favorable effects during the filtration process. First, application of vibration will prevent inadvertent differential sticking pressure between the exterior surface 25 of the filter 20 and the interior surface 33 of the immersion chamber 30, by causing movement of both the wall 31 of the immersion chamber 30 and the wall 21 of the filter 20. Additionally, the vibration generated by the one or more vibratory elements 50 will cause coffee grounds which may have been pulled toward the microperforations 28 of the filter 20 during flow of the brewed beverage through the microperforations 28, to translate or move slightly adjacent the interior surface 23 of the filter 20. By displacing the grounds which are obstructing or partially obstructing the microperforations 28, the patency of the microperforations 28 is improved, the area open to flow during filtration is maximized, and the filtration of the brewed beverage is accelerated.

In one vibratory mode, after the brewed mixture has steeped for a desired period of time (typically approximately four minutes), an air intake valve 58 may be opened to allow outside air to flow into the immersion chamber 30. Next, the dispensing valve 38 is opened, and one or more vibratory elements 50 are actuated. Opening of the air intake valve 58 prevents the formation of a restrictive negative pressure within the immersion chamber 30. In one version, the air intake valve 58 comprises a continually open port communicating to the atmosphere during the entire brew process and does not need to be opened. With one or more of the vibratory elements 50 actuated, the air intake valve 58 in an open position and the dispensing valve 38 in an open position, the brewed beverage will then flow through the microperforations 28 in the microperforated filter 20 at a rate exceeding that associated with just gravity feed.

The apparatus 10 may overcome the issue of reduced filtration rate by the application of vibratory energy, air pressure and air flow. In a vibratory embodiment and mode, the associated energy may be generated via the actuation of one or more vibratory elements 50 during the beverage filtration process. The vibratory elements 50 may be configured and tuned via the control unit 90 in correlation with the cross-sectional flow area of the filter 20 based on the total number of microperforations 28 in the filter 20, the density per square inch of microperforations 28 in the filter 20 and the preferred rate of beverage filtration.

In an alternative air-centric operational mode, wherein both air pressure and air flow may be applied to the immersion chamber 30, the apparatus 10 includes an air pump 86 and air control valve 88 used to pressurize the interior 39 of the immersion chamber 30 during the filtration process and enhance the filtration rate.

In an air-centric modality, the immersion chamber 30 is sealed during operation by a lid 32 configured to maintain air pressure generated by the air pump 80. With the air-centric mechanism, air pressure and air flow are used to effectively push the brewed beverage through the filter 20, decreasing filtration time. A dispensing region 34 may be provided near the bottom of the immersion chamber 30. In one configuration, the dispensing region 34 may be separated from the immersion chamber 30 by a sealing element 56, which may also function as a vibratory element 50. The sealing element 56, in conjunction with the microperforated filter 20, ensures that a minimal amount of air flows around the outside of the microperforated filter 20 and instead is directed to force the beverage portion of the brewed mixture to pass through microperforations 28 in the microperforated filter 20 and into the dispensing region 34 or directly into a receiving receptacle 60. The sealing element 56 in one instance is an elastomer, such as an O-ring. Alternatively, the sealing element 56 may be a shaped extension of the wall 31 of the immersion chamber 30. Additionally, the sealing element may house one or more vibratory elements 50.

A dispensing valve 38 controls the flow of the finished beverage from the dispensing region 34 to a receiver 60, e.g., a cup or carafe. The dispensing valve 38 may be manually controlled, electronically controlled, or designed to automatically and mechanically open after a specified time or when subjected to a certain pressure. The dispensing valve 38 may comprise an electric solenoid valve. The closing pressure of the dispensing valve 38 may be correlated to the pressure within the immersion chamber 30. For example, when the pressure in the immersion chamber 30 drops to a predetermined level due to substantial filtration of the brewed beverage from the brewed mixture, the air pump 86 could be timed to turn off and the dispensing valve 38 closed. During filtration of the brewed beverage from the brewed mixture, the air pressure within the immersion chamber 30 may vary. At the outset of pressurization, in one version, air pressure may vary between 1 and 3 PSI. Once most of the brewed beverage has been filtered, only air will flow through the microperforations 28 in the filter 20, and hence the air pressure will drop. Alternatively, the filtration time and hence the time for application of air pressure may be based on the amount of water initially used in the brewing process. Air pressure and air flow rate may be varied to allow adaptation to filters 20 having differing microperforation sizes.

The output of the air pump 86 into the immersion chamber 30 may be controlled via an air output valve 88. When a desired immersion time has been reached, the dispensing valve 38 may be opened, the air pump 86 may be actuated such that air will begin flowing into the immersion chamber 30 via the air output valve 88. As the air flows into the immersion chamber 30, the air pressure and flow of brewed beverage through microperforations 28 in the filtration walls 21 of the microperforated filter 20 causes the brewed beverage to be pushed through the microperforations and the coffee grounds and sediment to be pressed against an interior surface 23 of the filtration walls 21 of the filter 20. This process causes a “filter cake” to build up on the interior surface 23 of the filter 20, further enhancing the ability to minimize the transport of sediment into the finished beverage.

The vibratory mode and air-centric mode may each be used as a sole modality or in combination. The air control valve 88 is adjustable to allow air to be pumped through a supply conduit and into the interior 39 of the immersion chamber 30 during the filtration process at variable rates and at variable pressures. The vibratory elements 50 and the air pump 86 may be operated concurrently or sequentially to optimally accelerate the filtration of the finished beverage from the brewed mixture. In various configurations, the control unit 90 may operate the vibratory elements 50 and the air pump 86 in differing sequences and for differing durations to optimize the filtration process, or to enable other functionality such as dissipation of carbon dioxide gas during the brewing process.

With continued reference to FIG. 3, further description of features associated with the vibratory mode of operation is provided. One or more vibratory elements 50 interact with the wall 31 of the immersion chamber 30 during filtration of the finished beverage from the brewed mixture. The vibratory elements 50 may comprise any suitable components, such that they produce vibratory movement of the brew mixture. Examples of such elements include piezoelectric elements that deliver vibratory forces, a mechanical device that produces vibratory energy (such as a motor driven rod or other component that is caused to vibrate at a suitable frequency) and so on. A vibratory element 50 may comprise a transducer 1610. Each vibratory element 50 may also include one or more acoustic coupling components, such as rubber gaskets, that help to optimally couple vibrational energy to the wall of the immersion chamber 30. Additionally, the transducers 1610 associated with the vibratory elements 50 may be epoxied to the wall 31 of the immersion chamber 30, or otherwise mechanically affixed to the wall 31, such as with a bolt, screw or weld, so as to provided appropriate acoustic-structure interaction between the transducer 1610 and the wall 31 of the immersion chamber 30.

Although not shown herein, a vibratory element 50 may comprise a vibratory table. The control unit 90 may include a suitable control or driver circuit with an appropriate signal/waveform generator 1620 to cause the energy from one or more vibratory elements 50 to emit vibratory forces at desired frequencies.

Signal amplitudes and frequencies applied via a vibratory element 50 may be selected based upon a preferred rate of filtration and other preferred operational properties. A vibratory element 50 used for initial testing operated in a frequency range between 1 Hz and 660 Hz; others, e.g., piezoelectric transducers 1610, operate into the ultrasonic range, more than 16 KHz. During testing, frequencies as low as 1 Hz were shown to enhance filtration of the brewed beverage through the filter 20. Higher frequencies likewise accelerated filtration of the brewed beverage.

The apparatus 10 is configured to support various vibratory element 50 configurations, operational parameters and placement. The control unit 90 includes computational capability that allows sensors 500 to provide feedback concerning the coffee filtration process to establish certain parameter values including selection and tuning of applied frequencies. The control unit 90 supports variable configuration that is adaptable to optimize the rate of filtration of the finished beverage while simultaneously minimizing the amount of fines, silt and sediment transported into the finished beverage. The control unit 90 and associated programmable logic instructions are adaptable to allow selection of beneficial acoustic and mechanical frequencies to optimize movement of the coffee grounds near the interior surface 23 of the filter 20 to provide higher available flow area during filtration.

The control unit 90 and associated programmable logic instructions 92 are likewise adaptable to provide selection of beneficial mechanical and acoustic frequencies to minimize the movement of silt, fines and sediment through the microperforations 28 during filtration. According to the inventive subject matter, higher frequencies are applied to impact the region nearer the interior surface 33 of the immersion chamber 30. Lower frequencies are applied to create movement throughout the brewed mixture, e.g., when accelerating dissipation of carbon dioxide gas from the brew mixture. In addition, the inventive subject matter allows vibratory element 50 configurations and acoustic signal frequency selection to create wave patterns within the brew mixture which impact the particles in the brew mixture to impede their progress toward the microperforations 28 while allowing passage of the brewed beverage through the filter microperforations 28.

For example, in one aspect, it is desirable to apply vibratory energy sufficient to agitate coffee grounds adjacent the interior surface 23 of the filter 20 to maximize the flow area of the filter 20 by avoiding plugging of microperforations 28 by coffee grounds. The inventive subject matter, in this aspect, preferably leverages ultrasonic frequencies such that standing waves associated with the application of the ultrasonic frequencies may be directed at a depth corresponding to the area adjacent the wall 21 of the filter 20.

In another aspect, the selected ultrasonic frequency transmitted by the vibratory elements 50 is 80 kHz. The spacing of standing waves in water associated with an operational frequency of 80 kHz is approximately one-quarter inch apart, whereas standing waves in water associated with a lower operational frequency of 25 kHz are approximately one inch apart. Consequently, in one instance, the apparatus 10 uses the application of ultrasonic energy in the range of 60 to 100 kHz. The control unit 90 is programmable to send control signals to the waveform generator 1620 and amplifier 1630 such that the frequencies transmitted by the vibratory elements 50 can be adjusted to balance the rate of filtration versus the amount of silt, fines and sediment observed in the finished brewed beverage.

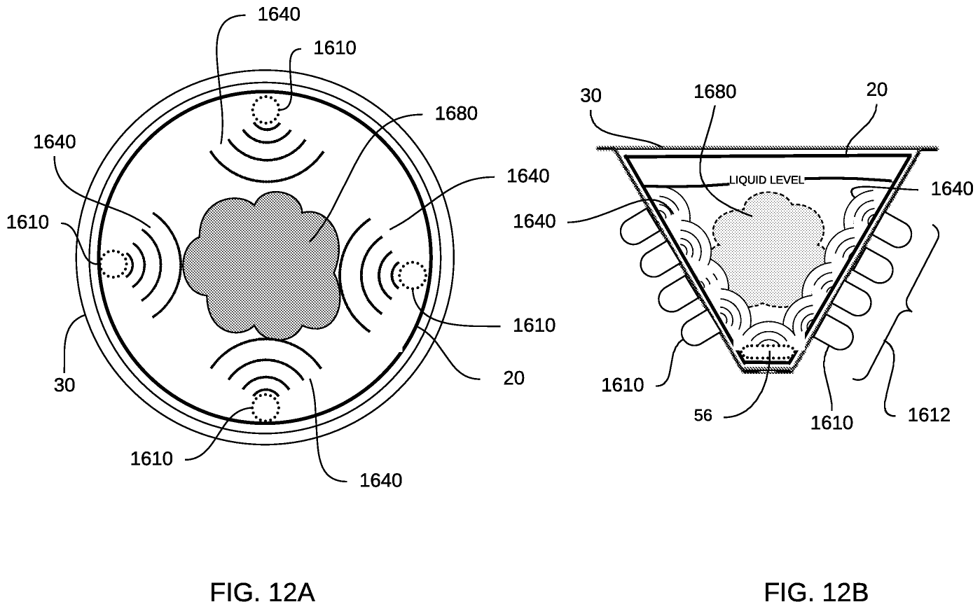

In other configurations, one or more of the vibratory elements 50 having different operational frequencies between 20 kHz and 160 kHz may be activated to both optimize the rate of filtration and minimize production of silt, fines and sediment in the finished brewed beverage. The application of acoustic energy from the appropriate configuration of vibratory elements 50 and selected acoustic frequencies may be used to generate favorable cymatic patterns in the brew mixture (see FIGS. 12A and 12B). In one instance, the cymatic patterns may be visualized using an imaging sensor to ensure that the coffee grounds and sediment in the brew mixture tend to aggregate in the center of the immersion chamber 30 during filtration. This visible cymatic indication that an appropriate frequency has been selected will enable the control unit 90 to control the pattern of the acoustic waves to minimize the transport of coffee grounds and other finer particles through the filter microperforations 28, thus creating a robust cup of French press equivalent coffee while reducing the amount of silt, fines and sediment in the finished beverage.

It has been observed that the application of certain ultrasonic frequencies to an aluminum foil sheet (e.g., such as that of the filter 20) can cause the aluminum foil to erode at high energy locations. The control unit 90 provides support for variation in the placement and power associated with each standing wave generated by a vibratory element 50. This controllable variability, with the use of variable emanated frequencies, will cause coffee grounds in proximity to the filter wall 21 to be agitated and moved while avoiding erosion of the filter media or damage of existing microperforations 28.

Consequently, in another embodiment, the use of higher frequency emissions in the range between 70 kHz and 90 kHz may be used to emit lower energy in a more uniform fashion, thereby minimizing erosion of the aluminum foil. The use of higher frequencies will also tend to eliminate the noise associated with lower frequency systems operating in the audible range. Ultrasonic frequencies, such as 80 kHz, are well beyond the human hearing range.

The vibratory elements 50 and associated operational frequencies are selected such that a portion of the emitted energy is absorbed by the filter 20 while other portions of the energy emanate centrally into the immersion chamber 30.

The vibratory elements 50 may comprise transducers which operate based on either magneto-restrictive or piezoelectric principals. The vibratory elements 50 may be attached to the immersion chamber 30 using epoxy, mechanical attachment or other means. In a preferred configuration, one or more vibratory elements 50 comprised of piezoelectric transducers 1610 operating at 80 kHz are attached to the wall 31 of the immersion chamber 30. In another configuration, a single vibratory element 56 may positioned at the bottom of the immersion chamber. In another configuration, the vibratory forces may be applied to the immersion chamber 30 via a vibratory table (not shown).

Vibratory energy from the vibratory elements may be applied in pulses or continuously. A pulsed application can be adapted to allow passage of the brewed beverage through the microperforations 28 while simultaneously applying energy to prevent coffee grounds and other fine particles from passing through the microperforations 28, causing the coffee grounds and other fine particles to aggregate more centrally in the interior portion 33 of the immersion chamber 30.

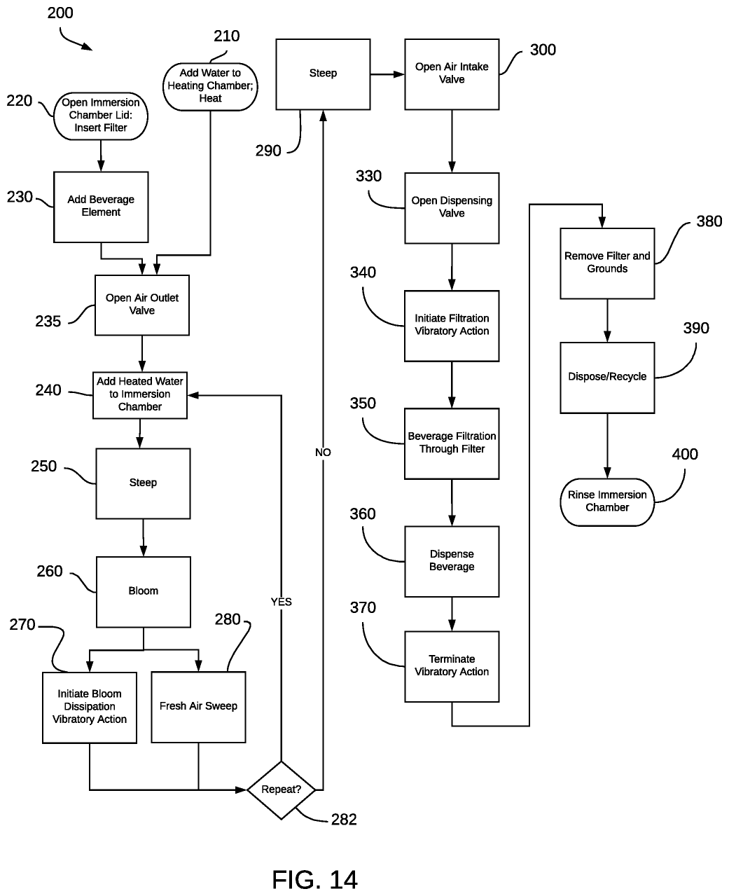

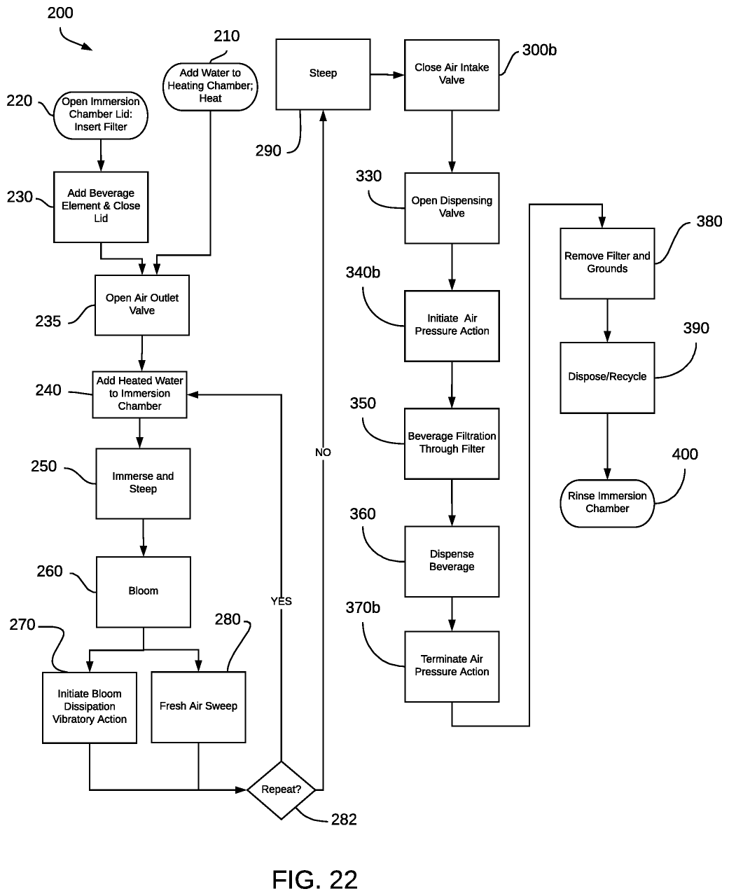

In another vibratory operational mode, vibratory energy from the vibratory elements 50 may be applied during steep phase 250 and bloom phase 260 (see FIGS. 14 and 22) to enhance degassing of carbon dioxide from the coffee grounds and brew mixture.

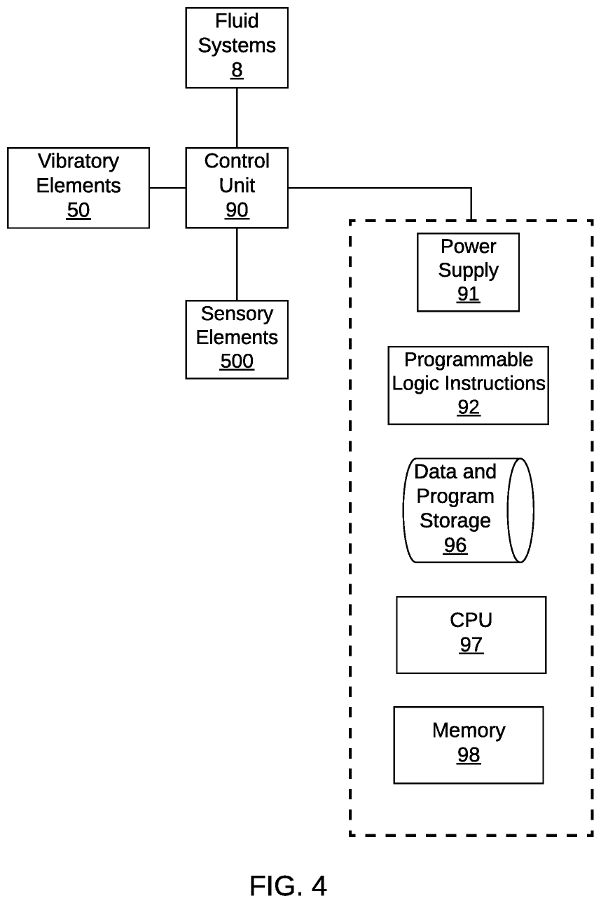

Referring to FIG. 4, a block diagram of primary components of the brewing apparatus are shown. The control unit 90 manages and orchestrates all fluid systems 8, vibratory components 1600 and sensory systems 500. The control unit 90 includes computer processing power (CPU) 97 and memory 98 configured to execute programmable logic instructions 92 that are embedded in memory 98 or provided via updateable software. The control unit 90 manages the components of the brewing apparatus 10 and the operation of those components.

The control unit 90 is configured to turn the vibratory elements 50 on or off. The control unit 90 monitors and operates all valve settings including an air intake valve 58, an air outlet valve 59, an air pump valve 88, water delivery valves 46 and a dispensing valve 38. The control unit 90 adapts the process and operation of the apparatus 10 and its components to achieve a desired filtration time. For example, the time for operation of the vibratory elements 50 may be correlated to the volume of water initially selected for use in the brewing process. The control unit 90 may vary vibratory frequencies and vibratory displacement to allow adaptation to different versions of the filter 20. For example, the control unit 90 can adapt the brewing process to consider differently sized microperforations 28, different filter material thickness, or to manipulate the coffee filtration process to suit an individual's taste preference.

In operation and use, the control unit 90 sends control signals to various components to cause water contained within a holding chamber 41 adjacent a water heating chamber 40 to be provided via a supply conduit 70 to a water pump 80 (such as a centrifugal pump, piston pump and solenoid pump). The water pump 80 transfers the water via a pump conduit 82 to the heating chamber 40. The control unit 90 may include a programmed processor and/or other data processing device along with suitable software or other operating instructions, one or more memories (including non-transient storage media that may store software and/or other operating instructions), one or more temperature sensors 550, liquid level sensors 520, pressure sensors 530, gas sensors 510, flow sensors 540, valve position sensors 560, input/output interfaces, communication buses or other links, a display, switches, relays, generators or other components necessary to perform desired input/output or other functions, including driving the vibratory elements 50 at desired frequencies and amplitudes.

The control unit 90 will issues commands to cause the heating chamber 40 to be filled with a desired amount of water by any suitable technique, such as running the pump 80 for a predetermined time, sensing a water level in the heating chamber 40, using a conductive probe sensor or capacitive sensor, detecting a pressure rise in the heating chamber 40 when the liquid is flowing into the heating chamber 40, or using any other such technique capable of measuring the volume of water in the heating chamber 40. For example, the control unit 90 may detect that the heating chamber 40 is sufficiently filled when a pressure sensor 530 detects a rise in pressure indicating that the water has reached the level in the heating chamber 40 associated with the desired volume of coffee to be brewed. Water in the heating chamber 40 may be heated by way of a heating element 44 whose operation is controlled by the control unit 90 using input from a temperature sensor 550. Water in the heating chamber 40 may be dispensed via a supply conduit 74 to the immersion chamber 30. The control unit 90 issues commands to cause the heated water to be discharged from the water heating chamber 40 and into the immersion chamber 30 by either gravity feed or by the water pump 80. Likewise, the control unit 90 will issue commands to terminate water transfer from the heating chamber 40 based on sensor input, for example, by detecting a pressure drop in the heating chamber 40, by detecting a water level change in the heating chamber 40, by use of a flow meter 540 and by measuring water level within the immersion chamber 30.

The water pump 80 may be a centrifugal pump, a piston-type pump or a metering pump such that a known volume of water may be delivered from the water pump 80 to the heating chamber 40, thus causing the same known volume to be delivered to the immersion chamber 30. In an alternative configuration, the holding chamber 41 may feed into a metering tank 72 to control the volume of water delivered to the heating chamber 40. During addition of heated water to the immersion chamber 30 in another operational mode, the air intake valve 58 and air outlet valve 59 will be opened to support degasification of the brew mixture and to generate a coffee aroma.

Referring now to FIG. 5, a description of components associated with the fluid systems 8 of the first brewing apparatus embodiment 10 are shown. The control 90 provides connectivity to each of the components in fluid systems 8. A holding chamber 41 holds water for heating. In one instance, water is transferred to a metering tank 72 for measurement to ensure the proper volume of water is heated. A water pump 80 transfers water from either the holding chamber 41 or metering tank 72 to the heating chamber 40 using an intake supply tube 70 and an output supply tube 82. Heating elements 44 within the heating chamber 40 heat the water to a desired temperature. Air pump 86 injects air into the immersion chamber 30 through supply line 74.

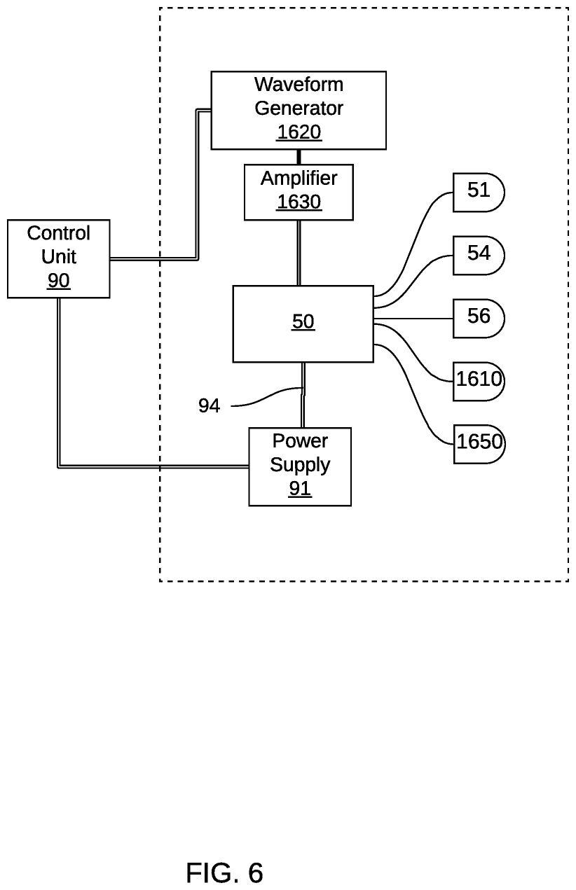

Referring now to FIG. 6, a block diagram illustration of primary elements associated with vibratory mode operation is shown. The control unit 90 manages operation of the vibratory elements 50 including a waveform generator 1620 and amplifier 1630. The control unit orchestrates the control and management of the elements, including the power supply 91 connecting across power cable 94 to drive the vibratory elements 50, including vibratory elements 51, 54, 56, 1610, 1650.

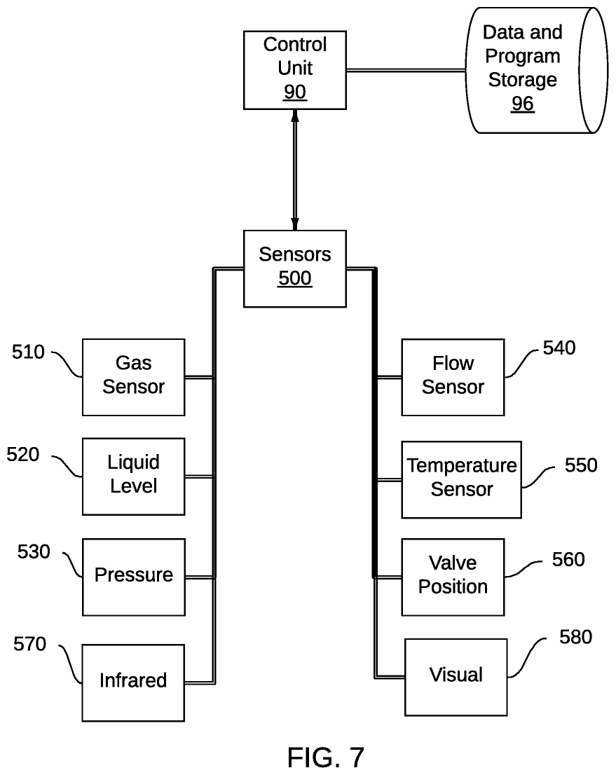

FIG. 7 is a block diagram of exemplary sensors 500 in communication with the control unit 90 that may be used to manage operation of the brew process. The data from the sensors 500 may be placed in data storage 96. One or more flow sensors 540 may be incorporated to measure both air and water flow at various locations throughout the fluid system 8. For example, a flow sensor 540 may measure fluid flow from the heating chamber 40 and into the immersion chamber 30 and finally into the dispensing region 34 and receiver 60. Temperature sensors 550 will monitor the temperature of the water as it is heating to ensure that the desired temperature is reached before the water is transferred to the immersion chamber 30. A gas sensor 510 may be deployed for monitoring the interior 39 of the immersion chamber 30 to assess the level of carbon dioxide being emitted during immersion and steeping of the brew mixture, particularly during the bloom phase. Based on data from the gas sensor 510, the control unit may react to turn on or turn off the air pump 86 used for removal and dissipation of carbon dioxide. A liquid level sensor 520 may be deployed within the heating chamber 40 to determine whether there is sufficient volume of water in the heating chamber 40 for production of the desired volume of coffee. The liquid level sensor 520 may also be used to inform the control unit 90 when a sufficient volume of appropriately heated water has been transferred to the immersion chamber 30. A pressure sensor 530 may be deployed within the interior 39 of the immersion chamber 30 to monitor the air pressure during the filtration process to ensure that the range is appropriate for the desired filtration rate and to ensure that the pressure does not increase beyond desired operating parameters. The pressure sensor 530 will send data that the control unit 90 may use to, for example, open a relief valve. A valve position sensor 560 may be used to determine which valves are open or closed. The valve position sensors 560 will inform the control unit 90 to ensure that all valves are properly positioned during any of the phases of the brewing process.

Referring now to FIG. 8, a more detailed schematic of components of a single exemplary vibratory mechanism 1600, operable during the filtration process is shown. The control unit 90 orchestrates and manages the operation of a wave form generator 1620 and amplifier 1630 to send control signals via electrical wires 1632 to a transducer 1610. The electrical wires 1632 deliver the signals to electrical nodes 1616 which are sandwiched within a piezo electric stack 1618. The electrical nodes 1616 are energized and de-energized to cause the piezoelectric stack 1618 to expand and contract at specific frequencies. The piezoelectric stack 1618 thereby causes energy to be transmitted to the front driver 1611 of the transducer 1610. The front driver 1611 transmits the energy to the immersion chamber wall 31, the filter wall 21 and into the brew mixture producing a desired waveform 1640 in the brew mixture. A rear compression component 1614 of the transducer 1610 applies sufficient compression to the piezoelectric stack 1618 to ensure appropriate and predictable operation of the transducer 1610 at desired frequencies. A single vibratory mechanism 1600 would support movement of the brew mixture to move coffee grounds off microperforations 28 during filtration of the brewed beverage.

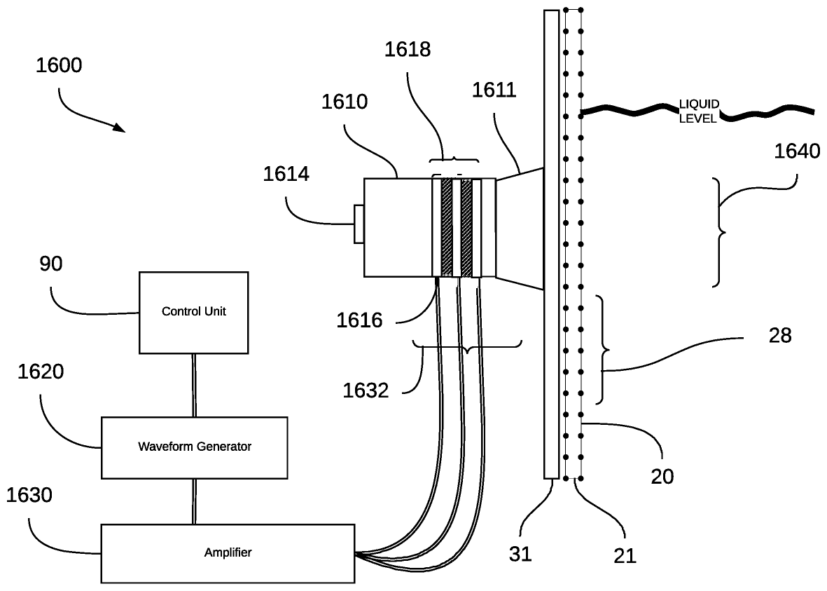

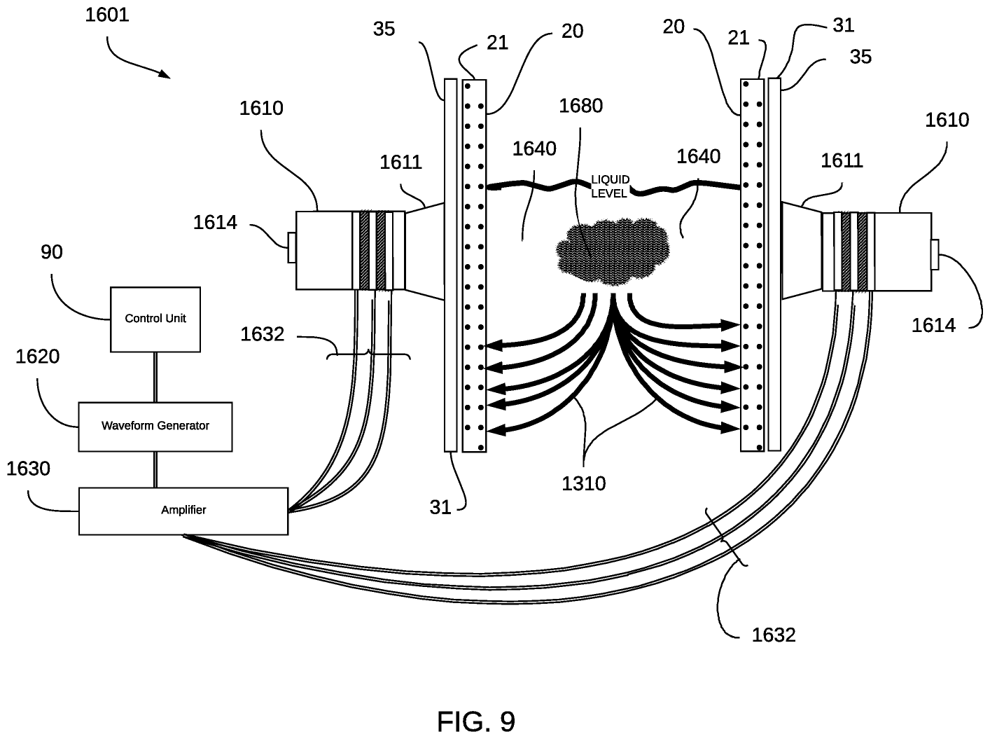

Referring now to FIG. 9, an exemplary schematic and illustration of the operation of a dual vibratory mechanism 1601 comprising two transducers 1610 according to the inventive subject matter is shown. In this illustration, two opposing transducers 1610 are driven by the control unit 90 to induce complementary wave forms 1640 into the brew mixture in the immersion chamber 30 during the filtration process. The complementary nature of the wave forms 1640 produced by the transducers 1610 cause coffee grounds and sediment to aggregate nearer the center of the immersion chamber 30, while the brewed beverage separates from the brew mixture and flows through the microperforations 28 in the filter 20. Thus, the dual vibratory mechanism 1601 minimizes the amount of sediment that may be carried along with the brewed beverage through the microperforations 28 of the filter 20. Even where particles may be pulled into the microperforations 28, potentially causing the microperforations 28 to become blocked or plugged during the filtration process, the vibratory forces generated by each transducer 1610 will cause the particles to move and translate continuously, reducing blocking or plugging of the microperforations 28. Multiple transducers 1610 of varied sizes and operational parameters may be deployed about the perimeter of the immersion chamber 30 to create differing vibratory geometries and apply variable forces to the immersion chamber 30 and the brewed beverage during filtration.

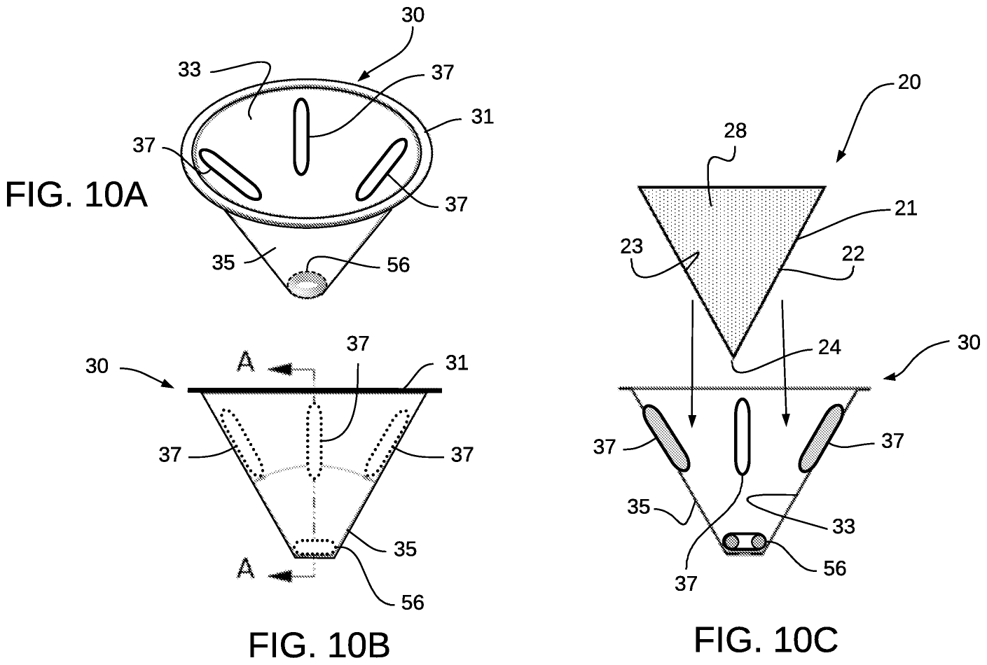

Referring to FIG. 10A-10C, in a preferred embodiment of the immersion chamber 30, one or more protruding spacers 37 extend from the interior surface 33 of the immersion chamber wall 31. The dimensions of the protruding spacers 37 may be adjusted to adapt the offset of portions of the microperforated filter 20 from the interior surface 33 of the immersion chamber 30. The offset enhances flow through the microperforations 28 and flow between the exterior surface 22 of the filter 20 and the interior surface 33 of the immersion chamber 30. In another embodiment (not shown), the immersion chamber 30 has a smooth interior with no spacers 37. An immersion chamber 30 without any spacers 37 would be easier to manufacture, but may result in slower filtration rates, especially in an exclusively air-centric system.

Referring now to FIG. 10A, a perspective view of a conically-shaped immersion chamber 30 is shown. FIG. 10B is a side elevation view of the conically-shaped immersion chamber 30 of FIG. 10A. FIG. 10C is a cross-sectional view of FIG. 10B, taken along the cross-section plane A-A, also illustrating the placement of a filter 20 within the immersion chamber 30 according to the inventive subject matter. The conically-shaped immersion chamber 30 includes an immersion chamber wall 31 having an interior surface 33 and an exterior surface 35. In one configuration, the immersion chamber 30 is operable without interior spacers 37. In another configuration, multiple spacers 37 may be distributed about the interior surface 33 of the immersion chamber wall 31. A sealing element 56 may be positioned at the bottom of the immersion chamber 30. The sealing element 56 is important when the air-centric modality and spacers 37 are use in conjunction with each other. While the spacers 37 are beneficial in allowing more space for fluid to flow through the filter 20, it also allows a potential passageway for air to flow around the filter 20 rather than through it. The sealing element 56 effectively forces the air to flow through the area of the filter 20 below the sealing element. The sealing element 56 may also house one or more vibratory elements 50 for dual function in an air-centric plus vibratory embodiment. Alternatively, in a vibratory-only mechanism, the sealing element 56 loses function as a sealing mechanism and only provides function as vibratory element 50.

Referring now to the cross-sectional view in FIG. 10C, the filter 20 includes a filter wall 21 having an exterior surface 22 and an interior surface 23. The filter wall 21 is permeated by a plurality of microperforations 28. The filter 20 includes a lower end 24 which may be positioned within the center core of the donut-shaped vibratory element 56.

Although shown herein as extending from the interior surface 33 of the immersion chamber 30, in a different configuration, the spacers 37 may alternatively or in combination be incorporated in the wall 21 of the filter 20. Additionally, although the spacers 37 shown herein are cylindrical or rib-like in nature, the spacers 37 may be more numerous and have various shapes such as protruding buttons or nubs. Additionally, the spacers 37 may be oriented in different positions and angles about the interior surface 33 of the wall 31 of the immersion chamber 30. For example, the spacers 37 may be angled at 45 degrees rather than in a vertical position. The dimensions of the spacers 37 may be varied and the number of spacers 37 may be varied. For example, instead of four spacers 37 having a width of one-half inch, the immersion chamber 30 may include sixteen spacers 37 having a width of one-sixteenth of an inch, with these small spacers distributed about the interior surface 33 of the wall 31 of the immersion chamber 30. One skilled in the art will recognize that other shapes and configurations of spacers 37 may be included to obtain the desired offset between the exterior surface 22 of the filter 21 and the interior surface 33 of the wall 31 of the immersion chamber 30. In another version, spacers 37 are molded into the filter 20 itself to provide a desired offset from the interior surface 33 of the immersion chamber 30. In still another version, neither the filter 20 nor the immersion chamber 30 includes spacers 37.

Spacers 37 extending inwardly from the interior surface 33 of the wall 31 of the immersion chamber 30 are sized to slightly offset portions of the wall 21 of the filter 20 from the interior surface 33 of the immersion chamber 30. In a standing wave system, the dimensions of the spacers 37 may be selected to coincide with the selected height of a standing wave emitted by the vibratory elements 50. The height of the standing wave may differ at different levels of the immersion chamber 30. For a conically-shaped immersion chamber 30, the preferred height of the standing wave may be smaller near the bottom end of the cone and taller near the top of the cone. Spacer 37 dimensions may then be created to coincide with the change in standing wave height. Conversely, sonic frequencies may be adapted to coincide with the dimensions of the spacers 37, where such frequencies are preferably between 20 kHz and 160 kHz. In a specific instance, where an operational frequency of 80 kHz is emanated from the vibratory elements 50, the spacers 37 may have a height of between one-quarter and one-half inch.

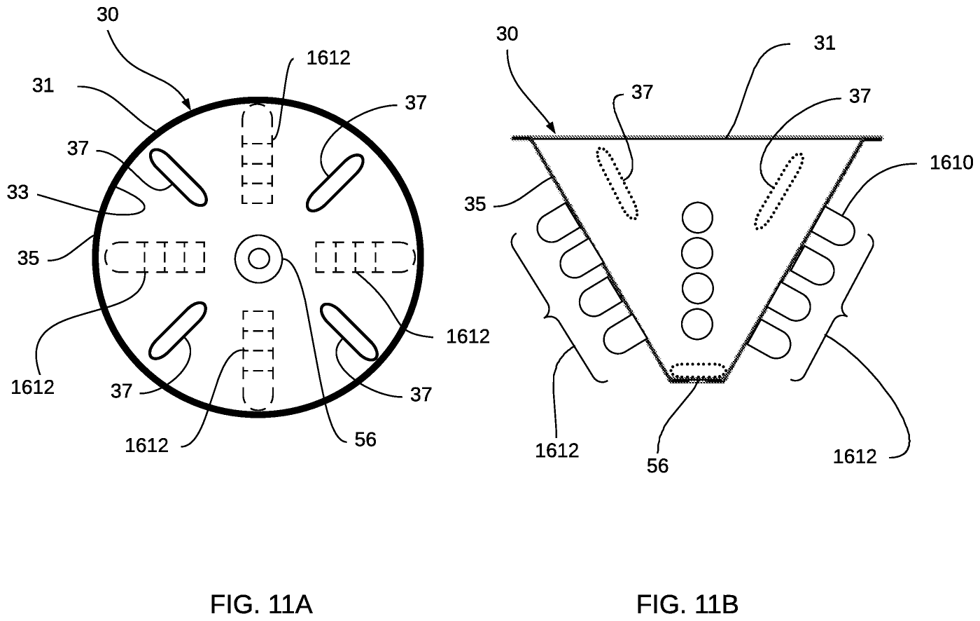

Turning now to FIG. 11A and FIG. 11B, an exemplary arrangement of transducer arrays 1612 distributed about the periphery of the conically-shaped immersion chamber 30 is shown. Four arrays 1612 comprising four transducers 1610 each are distributed evenly about the periphery of the conically-shaped immersion chamber 30 with 90-degree spacing. Additionally, a donut-shaped vibratory element 56 may be positioned at the bottom of the immersion chamber 30. Although shown as being placed within the interior 39 of the immersion chamber 30, the donut-shaped vibratory element 56 could also be located outside the immersion chamber 30.

FIGS. 12A and 12B provide additional views of the operation of the transducer arrays 1612 during the beverage filtration process, emphasizing movement and control of the placement of the coffee grounds. In the present configuration, each transducer 1610 produces vibratory energy generated inwardly to the center of the immersion chamber 30. In this vibratory mode, the transducers 1610 are not intended to create mixing of the brew mixture and instead, are intended only to enhance the filtration process and aid in degasification of the brew mixture. In one embodiment, the transducers 1610 are affixed to the conically-shaped immersion chamber 30 such that the vibratory energies are directed in both an inward and slightly upward direction, creating force vectors to maintain aggregation of the coffee particles in the center of the immersion chamber 30 during the filtration process.

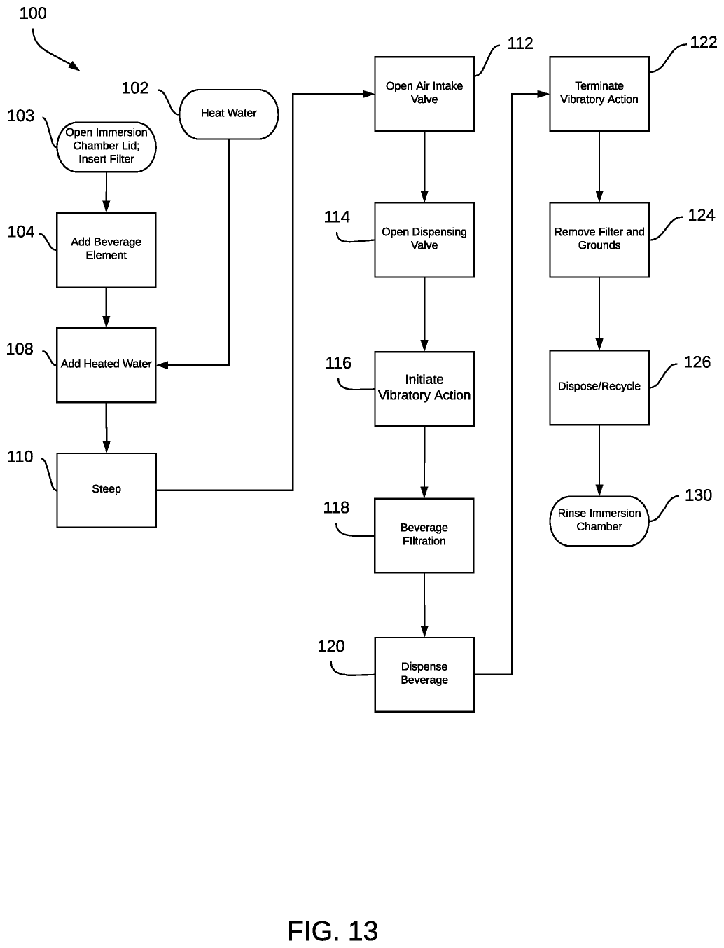

Referring now to FIG. 13, a flowchart illustrating the steps associated with a first beverage preparation method 100 focused on vibratory enhancement of filtration, according to the inventive subject matter, is shown. The first beverage preparation method 100 is shown in relation to the use of apparatus 10 as shown in FIG. 3. In step 102, the process of heating water to a preferred temperature, typically just below boiling, is begun. In step 103, a user opens the immersion chamber lid 32 and inserts a microperforated filter 20 into the immersion chamber 30. In step 104, the user adds a desired beverage element, e.g., coffee grounds, to the immersion chamber 30, placing the beverage element into the interior of the filter 20.

In step 108, heated water is added to the immersion chamber 30. In step 110, the beverage element mixes with the heated water and is allowed to steep for a desired time period. The steeping time will vary based on the desired properties of the finished beverage. Typical steeping time will be between three and five minutes. In one embodiment, the heated water is added in stepwise increments to facilitate mixing of the brew, until the total required amount of water has been added to the immersion chamber 30. In another embodiment, the water may be added through one or more nozzles (not shown) distributed about the perimeter of the immersion chamber 30 to enhance mixing. In one aspect of the inventive subject matter, the heated water used in brewing may be introduced in pulses through the water nozzles to further enhance mixing during the steeping phase.

After steeping the coffee and heated water mixture for a specific duration, e.g., four minutes, and with the immersion chamber lid 32 closed, multiple actions are taken to filter the finished beverage from the brew mixture. Steps 112, 114 and 116 described below may occur in any order. In step 112, an air intake valve 58, which may also comprise an open portal, is opened to allow outside air to enter the immersion chamber 30 to prevent creation of a vacuum which would slow or impede the filtration of the finished beverage though the filter 20. In step 114, the dispensing valve 38 is opened. In step 116, one or more vibratory element(s) 50 are actuated to deliver vibratory action through the wall 31 of the immersion chamber 30 and into the brew mixture to accelerate filtration of the brew mixture through the filter 20.

Having completed steps 112, step 114, and step 116, and further aided by gravity, in step 118, the process of filtering the brew mixture through filter 20 begins, resulting in the production of a finished beverage. The brewed beverage flows through the microperforations 28 of the microperforated filter 20 and may be collected in the dispensing region 34. The microperforations 28 are sized to allow the passage of hot water and desirable flavor elements provided by the beverage element, while minimizing the transfer of undesirable components, such as coffee grounds or silt. One or more protruding spacers 37 create a partial separation of the filter wall 21 from the interior surface 33 of the immersion chamber 30 to increase fluid flow through the microperforated filter 20 during the filtration process. In step 120, the finished beverage passes from the dispensing region 34 through the dispensing valve 38 into a receiver 60. In step 122, after the finished beverage has been satisfactorily dispensed, the control unit 90 terminates all vibratory action. In step 124, the filter and grounds are removed from the immersion chamber 30. In step 126, the filter and grounds are disposed of and/or recycled. In the case of a permanent filter, the filter is rinsed clean to be reused in the future. Finally, in step 130, the immersion chamber 30 may be removed and rinsed clean.

In a less automated configuration, the apparatus 10 comprises an immersion chamber 30 in the style of an open pour-over style cone (without a lid 32, heating chamber 40, or air valves 58, 59). A vibratory element 50 or array of vibratory elements 52 is attached to the immersion chamber 30. The vibratory element 50 may also comprise a vibratory table (not shown) supporting the immersion chamber 30 wherein a dispensing valve 38 extends laterally outward from the dispensing region 34 rather than directly down from the dispensing region 34. A manual dispensing valve 38 is used to block flow while the coffee grounds are immersed and steeped in an appropriate volume of heated water. A receiving vessel 60 is placed below the dispensing valve 38, and a microperforated filter 20 is placed within the immersion chamber 30. The beverage element, e.g., coffee grounds, is placed inside the filter 20. Water is manually heated to the desired temperature and manually added to the coffee grounds. At a specified time, e.g., one minute, the brew mixture is manually stirred to ensure adequate mixing of the beverage element and heated water for complete immersion. After an additional specified time, e.g., three minutes, the dispensing valve 38 is opened, and the vibratory element 50 or vibratory array 52 is actuated to accelerate filtration of the brew mixture, resulting in collection of the finished beverage within the receptacle 60.

Referring now to FIG. 14, a flowchart illustrating steps of a second beverage preparation method 200 using the apparatus 10 in a vibratory mode for enhancement of filtration and degasification is shown. In step 210, the user removes the water chamber lid 42 and adds a quantity of water to the heating chamber 40, and the water is heated. The water in the heating chamber 40 is heated by one or more heating elements 44 to a desired brewing temperature, typically around 200 degrees Fahrenheit. In step 220, a user opens the immersion chamber lid 32 and inserts a microperforated filter 20 into the immersion chamber 30. In step 230, the user adds a desired beverage element, e.g., coffee grounds, to the truncated conical microperforated filter 20 in the immersion chamber 30.

In step 235, an air outlet valve 59 on the immersion chamber 30 is opened to avoid positive back pressure when adding water to the immersion chamber 30. In step 240, a first desired amount of heated water is transferred from the heating chamber 40 to the immersion chamber 30 via a water transfer valve 46. The initial volume of heated water may be less than the final target volume to allow for addition of heated water later during the steeping period to address other issues in the mixing.

In step 250, the heated water mixes with the beverage element, the beverage element is immersed and is allowed to soak, i.e., “steep”, for a targeted duration. As coffee grounds steep in the heated water, they are known to coalesce near the surface of the brew mixture, forming a “crust”. The “crust” may interfere with the mixing of the grounds and heated water and full immersion, thus step 240 may be repeated 282 as necessary by adding additional heated water to help break the “crust” and facilitate full immersion of the coffee grounds. Heated water may be added in increments until the total desired water volume has been added to the immersion chamber 30. Alternatively, a separate mixing mechanism such as one or more water nozzles (not shown) may be used to enhance mixing of the brew mixture. Other approaches for mixing the brew mixture may likewise be employed, e.g., a mechanical stirring device or any other approach which will impart momentum to the mixture sufficient to mix the coffee grounds and heated water for thorough immersion and soaking.

It is also known that as coffee grounds steep in heated water, the grounds will initially release carbon dioxide as a gas, which can cause the brewed beverage to be acidic, which is an undesirable outcome. This carbon dioxide release is called a “bloom” and appears as bubbles on top of the brew mixture. Thus, the air outlet valve 59 provides an additional function to allow the dissipation of the carbon dioxide bloom generated from the immersion of coffee grounds in the heated water during the bloom phase 260. Expelling this undesirable carbon dioxide from the immersion chamber 30 will minimize contamination of the brew mixture by dissolved carbon dioxide, which can create a more acidic brew. The resultant brew mixture will have lower acidity, ultimately producing a smoother, less bitter cup of coffee.

Additional measures including a dissipatory-vibratory action phase 270 and a fresh air sweep 280 may be taken to minimize the contact time between the carbon dioxide bloom and the brew mixture during the bloom phase 260, again resulting in a better tasting cup of coffee. These measures may be initiated during the steep phase 250 to minimize accumulation of the bloom and quickly degasify the brew mixture.

During the dissipatory-vibratory action phase 270, the control unit 90 initiates vibratory action to help accelerate dissipation of the carbon dioxide bloom. This may be achieved by actuating one or more vibratory elements 50 to agitate the wall 31 of immersion chamber 30 or the brew mixture directly. In another configuration, the brew mixture may be agitated via a vibratory probe 1650 which is positioned within the immersion chamber 30 down through the brew mixture. Other configurations may include any combination of vibratory elements 50 listed above. In addition, vibratory elements 50 may be supplanted or enhanced via a vibratory table (not shown).

Simultaneous to the dissipatory-vibratory action phase 270, the control unit 90 may initiate a fresh air sweep 280. During the fresh air sweep 280, an air mover, e.g., an air pump 86, is activated and air intake valve 88 opened to allow fresh air to sweep through the immersion chamber 30 to assist in flushing out the carbon dioxide generated during the bloom phase 260 and dissipatory-vibratory action phase 270. The air sweep 280 includes movement of fresh air through the interior 39 of the immersion chamber 30, flushing carbon dioxide through an outlet valve 59 and out of the immersion chamber 30. The outlet valve 59 may comprise an open port or an operational valve.

The initiation and cessation of the dissipatory-vibratory action phase 270 and fresh air sweep 280 may be manually controlled, controlled by a timer, or controlled with the help of a carbon dioxide sensor 510 that tracks the level of carbon dioxide in the immersion chamber 30 during the steeping phase 250 and bloom phase 260. As the level of carbon dioxide changes within the interior 39 of the immersion chamber 30 during the fresh air sweep 280, the carbon dioxide sensor 510 will trigger termination of both the dissipatory-vibratory action phase 270 and fresh air sweep 280 when the carbon dioxide content has dropped appreciably to a level consistent with the content of carbon dioxide in the atmosphere.

The total desired volume of heated water (corresponding to the number of cups of coffee to be brewed) may be added 240 to the immersion chamber 30 in one step, or, in several steps with smaller portions of heated water added to the immersion chamber 30 until the total desired volume has been added. Where water is added in several smaller portions rather than one large portion, steps 240 through 280 are repeated 282 until the total desired volume is added and the bulk of carbon dioxide produced has been dissipated. In step 290, the brew mixture steeps for an additional amount of time according to an individual's taste preference.

Once the brew mixture is fully immersed and sufficiently steeped, the control unit 90 initiates steps associated with the filtration process. These steps need not occur in the order listed below. One skilled in the art will recognize that the steps described below may occur in different order. In step 300, air intake valve 58, which may comprise an open portal, is opened to prevent formation of a negative pressure within the interior 39 of the immersion chamber 30 which would impede filtration. Next, in step 330, the dispensing valve 38 is opened.

In step 340, the control unit 90 initiates one or more vibratory elements 50 to agitate the wall 31 of the immersion chamber 30 to enhance the filtration of the brewed beverage through the filter 20 versus gravity alone. As with the dissipatory-vibratory action 270, the filtration-vibratory action 340 may be achieved by any combination of vibratory elements 50, 54, 56, 1650 and further supplanted or enhanced by a vibratory table.

In step 350, comprising filtration of the beverage through the filter 20, the finished beverage flows through the microperforations 28 of the microperforated filter 20 into a dispensing region 34. The dispensing region 34 may be sized to receive the entirety of the volume of the finished beverage, or just a portion. The microperforations 28 are sized and shaped to allow the filtration of the brew mixture in a satisfactory time frame (as accelerated by vibratory energy) while minimizing the passage of undesirable components such as coffee grounds or silt. One or more protruding spacers 37 may be used to establish an offset distance from the exterior surface 22 of the filter wall 21 from the interior surface 33 of the immersion chamber 30 to prevent the exterior surface 22 of the filter wall 21 of the filter 20 from creating a sticking pressure differential between the interior surface 33 of the immersion chamber 30 and the exterior surface 22 of the filter 20.

In step 360, the finished beverage is dispensed from the dispensing region 34 through the dispensing valve 38 into a receiver 60. Steps 350 and 360 may overlap, such that the dispensing of beverage 360 occurs at the same time as beverage filtration 350. Once filtration 350 is complete, the control unit 90 terminates all vibratory action in step 370. In step 380, the filter and spent grounds are removed. In step 390, the disposable filter is disposed of or recycled; or in the case of a permanent filter, the filter is rinsed off Finally, in step 400, the immersion chamber may be rinsed and prepared for future use.

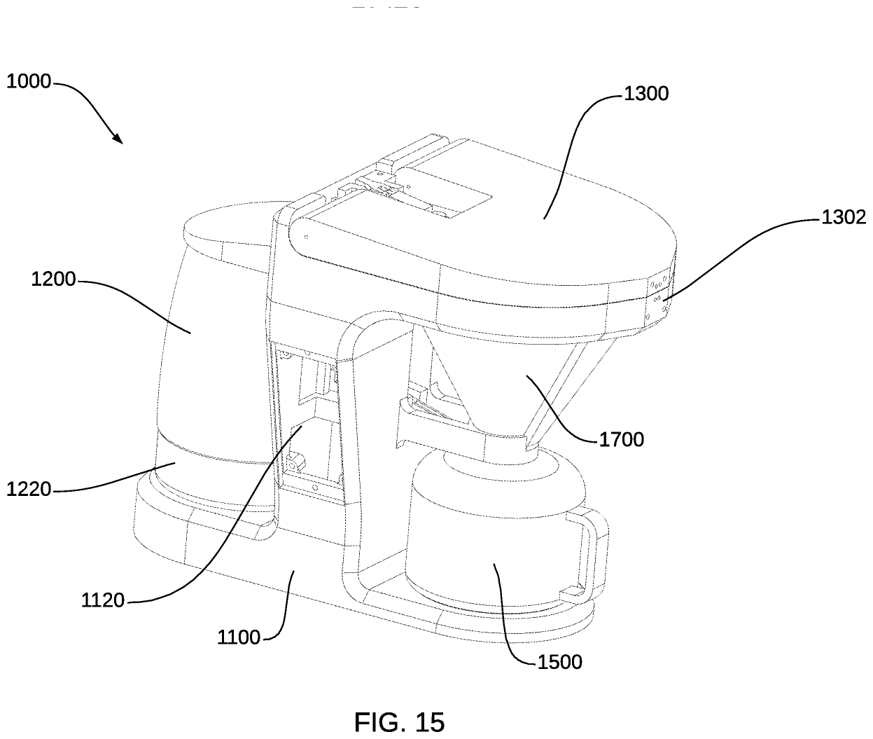

FIG. 15 is a perspective view of a second embodiment 1000 of the brewing apparatus using air pressure and flow as means for enhanced filtration, according to the inventive subject matter. The second embodiment 1000 comprises housing 1100 for supporting the various components of the brewing apparatus 1000. For prototypes, the housing 1100 has been from plastic material produced using 3-D printing techniques. A control module compartment 1120 is provided in a central portion of the housing 1100 to receive one or more control units 90 for operational control of the brewing apparatus 1000. A water heating vessel 1200 having a water heater element 1220 is positioned on a first side of the housing 1100. An immersion chamber 1700 is positioned on the opposing side of the housing 1100. A lid 1300, lid seal 1320 and lid closure 1302 ensure that air pressure is contained within the immersion chamber 1700 during the air-centric filtration process. A carafe or pot 1500 is positioned below the immersion chamber 1700 to receive the finished beverage.

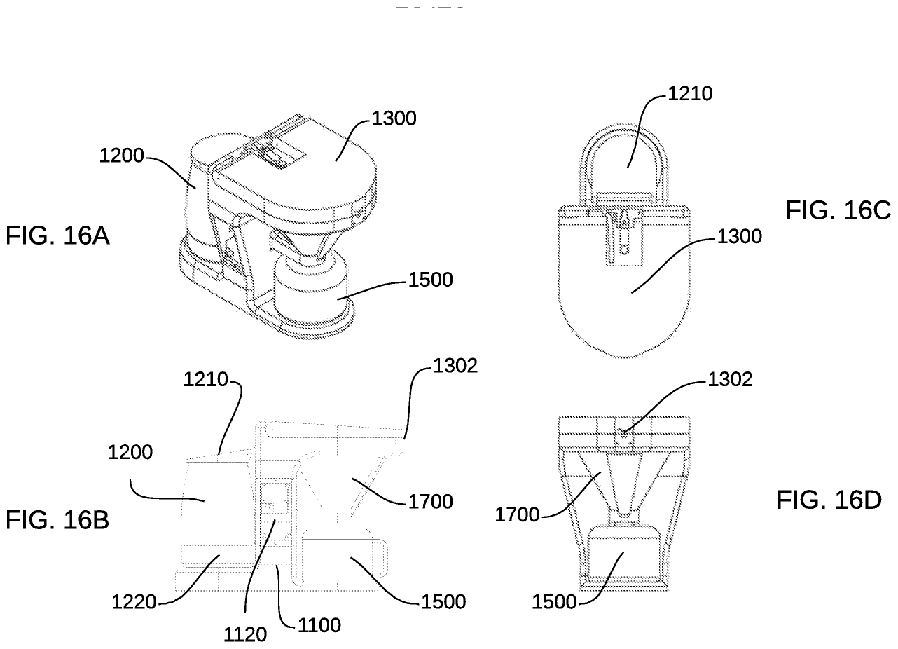

Turning now to FIG. 16A through 16D, several views of the brewing apparatus 1000 are shown. FIG. 16A is a top perspective view of the air-centric apparatus shown in FIG. 15, illustrating placement of the heating vessel 1200, the immersion chamber lid 1300 and the receiving carafe 1500. FIG. 16B is a side elevation view of the air-centric apparatus shown in FIG. 15. This view further illustrates placement of various components including the heating vessel lid 1210 and the immersion chamber lid closure 1302. FIG. 16C is a top plan view of the air-centric apparatus shown in FIG. 15, once again illustrating the orientation of the heating vessel 1200 and its lid 1210, as well as the immersion chamber 1700 and its cover 1300. FIG. 16D is a front elevation view of the air-centric apparatus 1000 shown in FIG. 15. In this view, the positioning of the carafe 1500, the immersion chamber 1700 and the immersion lid closure 1302 are shown.

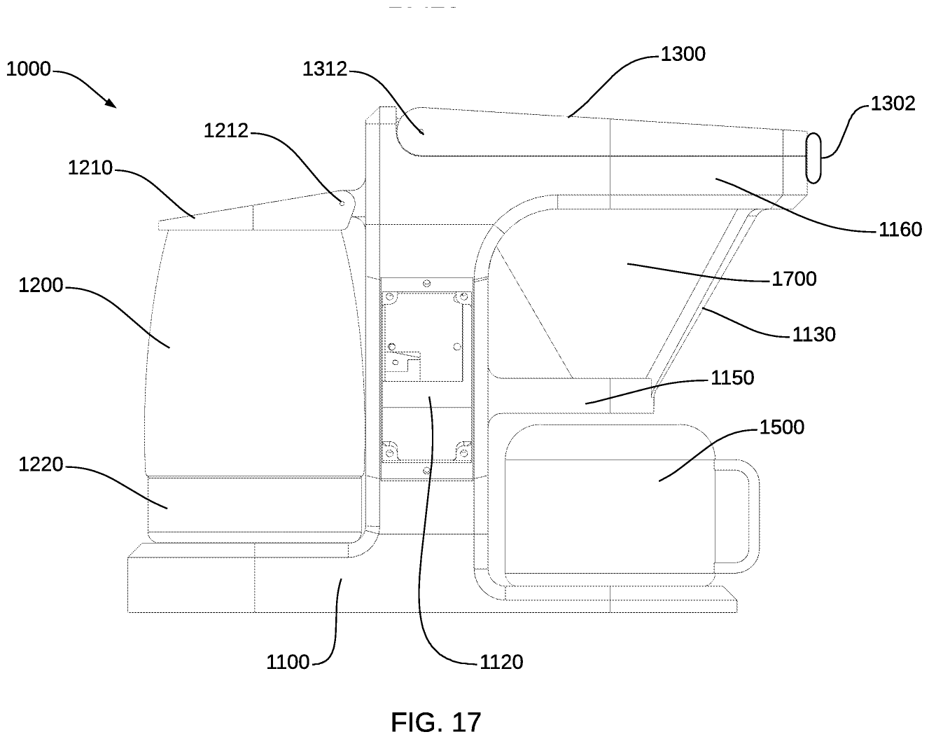

FIG. 17 is an enlarged side elevation view of the second embodiment 1000 of the brewing apparatus shown in FIG. 15. The immersion chamber lid 1300 is rotationally connected to the housing 1100 via hinge points 1312. Likewise, the heating vessel lid 1210 is rotationally connected to the housing 1100 via hinge points 1212. Additional portions of the housing include a lower frame brace 1150, a forward stanchion 1130 and an upper rim support 1160. The lower frame brace 1150 encloses elements of the bottom valve assembly. The forward stanchion 1130 provides structural support for the immersion chamber 1700 and the lower frame brace 1150. The forward stanchion provides structural connectivity between a distal end of the lower frame brace 1150 and the upper rim support 1160. Additionally, lid closure latch 1302 is shown. During air-centric operational mode, the closure latch 1302 ensures that the lid 1300 remains closed and sealed during the application of air pressure.

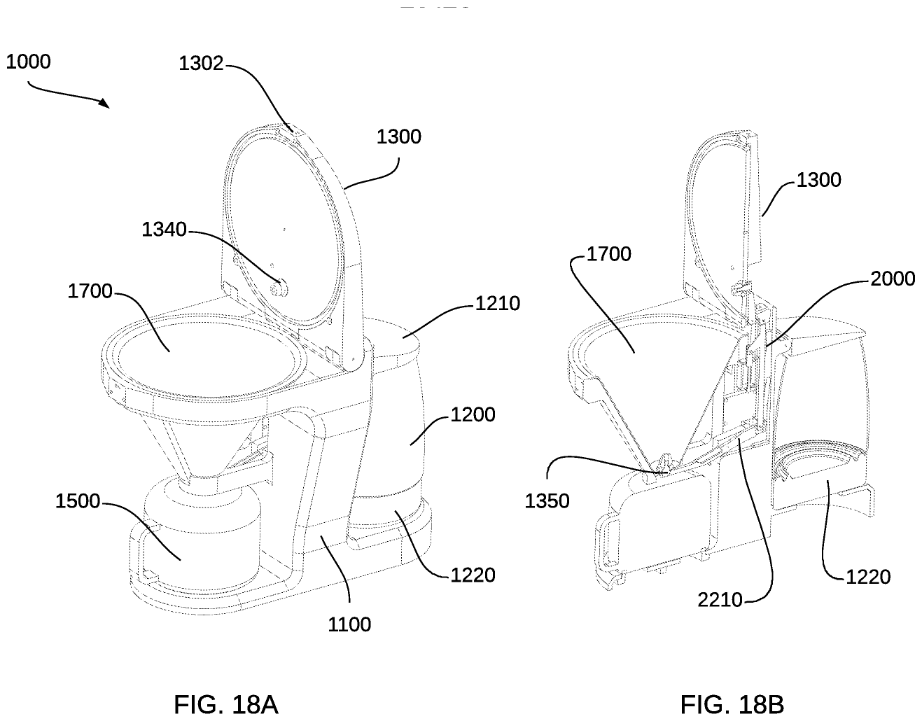

FIG. 18A is another perspective view of the second brewing apparatus embodiment 1000 in FIG. 15, shown with its immersion chamber lid 1300 rotated to an open position which provides a user with access to the immersion chamber 1700 for placement or removal of a filter 20 and coffee grounds. Shown in the open position, the upper air plug valve 1340 is shown. FIG. 18B is a cross-sectional view of the apparatus shown in FIG. 18A. In this view, the valve linkage assembly 2000 can be seen. The linkage assembly 2000 includes a lower transfer arm 2210. In addition, the lower dispensing water plug valve 1350 is shown.

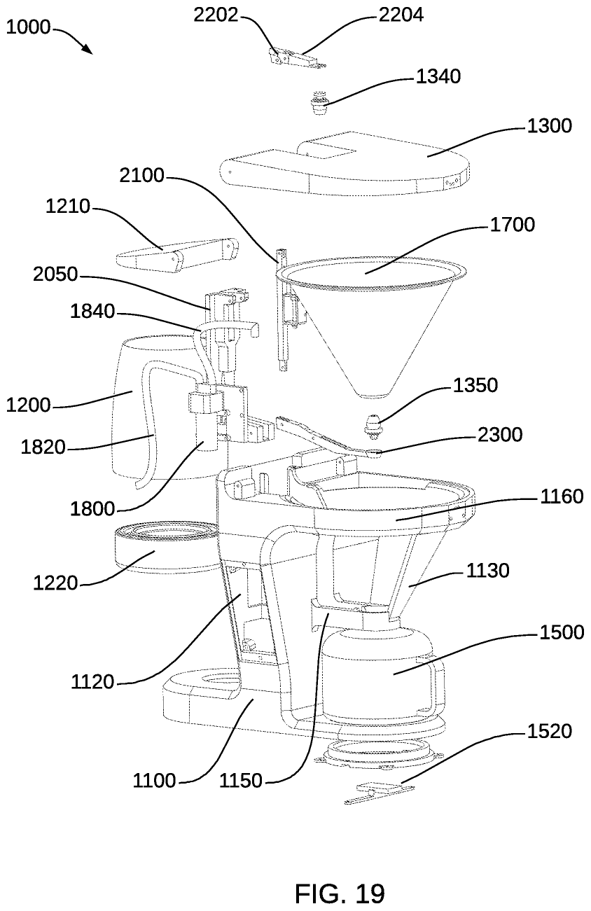

FIG. 19 is an exploded perspective view from a first side of the second brewing apparatus embodiment 1000. Additional details of the configuration of the second embodiment 1000 are illustrated. Aspects of the linkage assembly 2000 are first described. A vertical transfer arm 2100 is slidably engaged with lever frame 2050. A top rocker lifter arm 2202 and atop rocker transfer arm 2204 are hingedly engaged with the top of the vertical transfer arm 2100. A lower arm 2300 is hingedly engaged with the lower portion of the vertical transfer arm 2100. The top rocker lifter arm 2202 and top rocker transfer arm 2204 open and close the top air plug valve 1340. The lower arm 2300 opens and closes the lower water plug valve 1350.

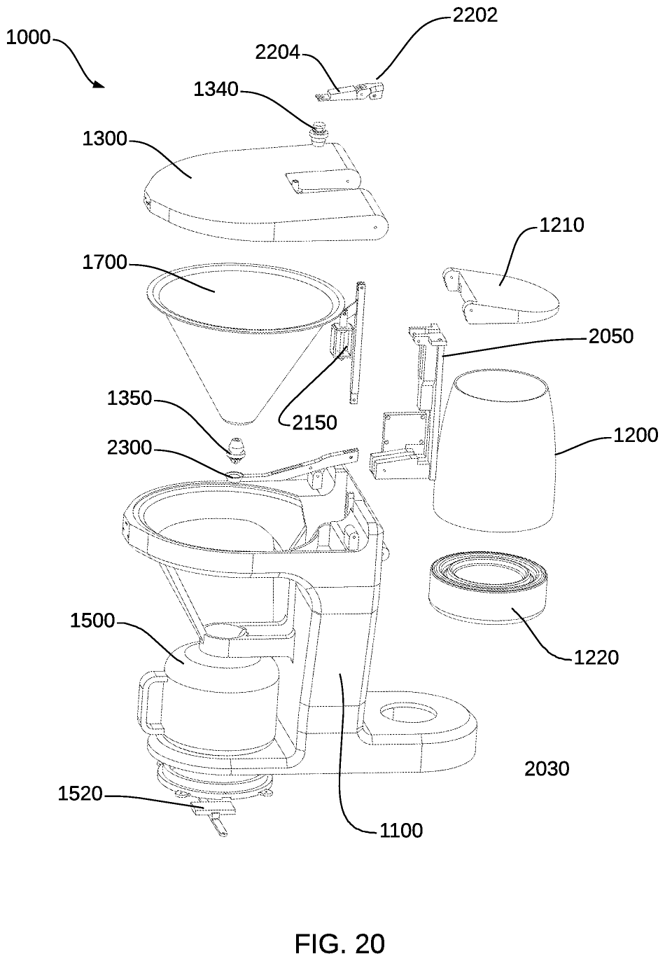

Turning to FIG. 20 which is the same exploded view as shown in FIG. 19, but from the opposite side, additional components of the linkage assembly 2000 are shown. The vertical transfer arm 2100 is engaged with an electric solenoid 2150 that drives the vertical transfer arm in an up-and-down direction. When driven downward, and operating in an air-centric modality, the components of the valve linkage assembly 2000 are positioned to dispense beverage. When driven upward, the components of the valve linkage assembly 2000 are positioned for filling, immersion and steeping. In the dispense position, the lower arm 2300 is raised which lifts and opens the lower water plug valve 1350, allowing finished beverage to be dispensed. Simultaneously, the upper air plug valve 1340 is closed, ensuring that any air pressure is directed to push the brewed beverage through the filter 20 and out the lower water plug valve 1350 into a receptacle 1500.

In contrast, in a filling, immersion and steeping position, the vertical transfer arm 2300 is driven by the solenoid 2150 to an upper position, causing the lower arm 2300 to drop and causing the lower water plug valve 1350 to seat and close. Simultaneously, the upper air plug valve 1340 is in an open position, allowing air to escape as the immersion chamber 1700 is filled with heated water, and supporting dissipation of any produced carbon dioxide during immersion and steeping, e.g., associated with a bloom phase.

Returning to FIG. 19, a combined water and air pump 1800 is used to pump heated water from the heating vessel 1200 and into the immersion chamber 1700. A supply tube 1820 is positioned within the heating vessel and a filling tube 1840 transfers the heated water into the immersion chamber 1700. During the filling phase, the pump 1800 pumps water into the immersion chamber 1700. After the brew mixture has sufficiently steeped and is ready to be filtered through the filter 20, the supply tube 1820 is used as an intake for air and the pump 1800 serves the dual purpose of increasing the air pressure within the interior of the immersion chamber 1700 during filtration and dispensing.

The water heating element 1220 is positioned under the heating vessel 1200 and is configured to ensure that the water temperature is raised to the appropriate temperature before filling. A separate heater 1520 is positioned under the carafe 1500 as a warming plate to keep the finished beverage at a desired temperature for consumption. The advantage of two separate heating elements is in keeping the finished beverage from developing a scorched bitter taste. The purpose of heating element 1220 is to boil room temperature water as quickly as possible. As such, the heating element 1220 reaches extremely high temperatures, exceeding 300 degrees Fahrenheit. The warming plate 1520, however, has the purpose of maintaining the finished beverage at a comfortable drinking temperature, typically between 130-170 degrees Fahrenheit. Using a single heating element exceeding 300 degrees Fahrenheit for both functions, as is typical for most automatic drip machines, results in an overly hot warming plate, which eventually will burn the coffee if the carafe 1500 is left on the warming plate for any extended period of time. The 300 degree Fahrenheit warming plate also poses a significant fire hazard.

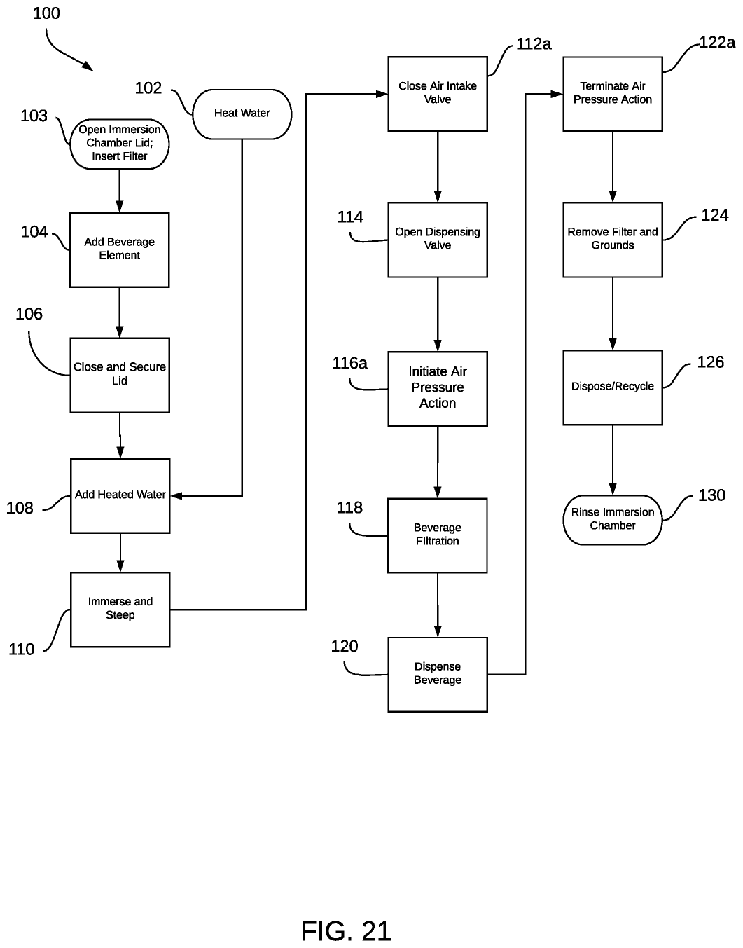

FIG. 21 is a flowchart illustrating the steps of a second beverage preparation method using air pressure and flow for filtration, according to the inventive subject matter. This method is consistent with earlier described methods for vibratory mode filtration with the changing of certain steps to support containment of air pressure. For air-centric filtration, at step 106, the lid 1300 to the immersion chamber 1700 must be closed securely in order to maintain a pressurized environment. At step 112a, the upper air plug valve 1340 is closed. At step 116a, the air/water pump 1800 is initiated to increase air pressure to drive the brewed beverage through the filter 20. At step 122a, air pressure action is terminated by turning off the air/water pump 1800.

FIG. 22 is a flowchart illustrating the steps of the second beverage preparation method in FIG. 21 using air pressure for enhanced filtration and including gas dissipation steps, according to the inventive subject matter. In this operational mode, at step 300b, the air intake valve 1340 is closed. At step 340b, the air/water pump is triggered to initiate air pressure action. At step 370b, air pressure action is terminated by turning off the air/water pump 1800.

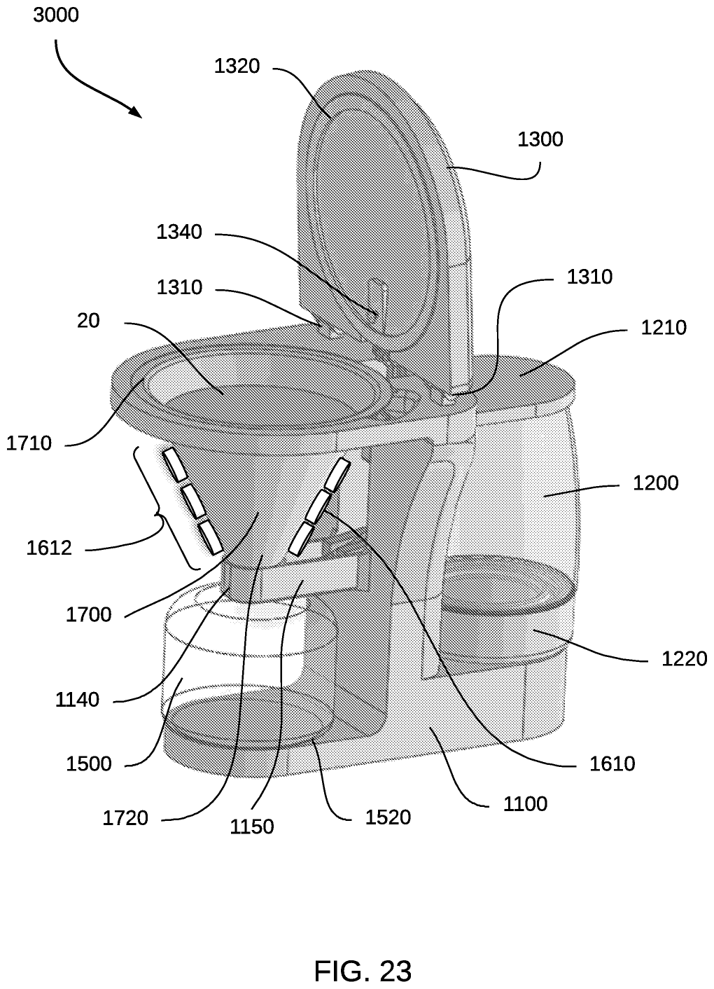

Referring now to FIG. 23, a perspective view of a third embodiment 3000 of a hybrid brewing apparatus according to the inventive subject matter is shown. This third hybrid embodiment 3000 includes multiple vibratory transducers 1610, as well as an air-centric pressure and flow component, all of which support acceleration of filtration. As with the air-centric brewing apparatus 1000, the hybrid embodiment 3000 includes equivalent functional and structural components, but with the addition of vibratory features. Hence, this description focuses on the differences in the hybrid embodiment 3000 from the air-centric embodiment 1000.

First, one or more transducers 1610 or transducer arrays 1612 may be distributed about the perimeter of the immersion chamber 1700. Each array 1612 is comprised of two or more transducers 1610. A filter 20 for receiving coffee grounds is deployed within the interior of the immersion chamber 1700. The bottom 1720 of the immersion chamber 1700 is received in the dispensing mechanism pocket 1140. An upper air plug valve 1340 used for pressure release and containment is deployed within the lid 1300. The lid 1300 further includes a circular sealing portion 1320 that mates with a circular sealing surface 1710 of the immersion chamber 1700 when the lid 1300 is closed.

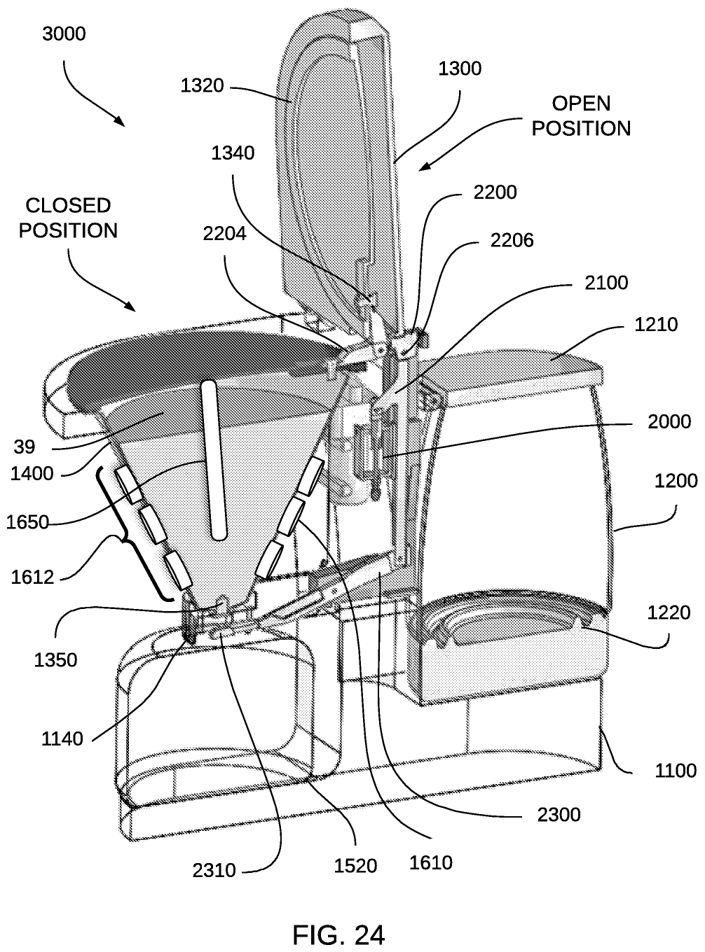

Referring now to FIG. 24, a cross-sectional view of the brewing apparatus 3000 is shown to further identify other components. In addition to transducers 1610 deployed on the immersion chamber 1700, an additional rod transducer 1650 may be deployed through the lid 1300 to enhance degasification during the bloom phase 260 and steep phase 250 of brewing process and may also enhance filtration of beverage during the filtration phase 350.

As with the air-centric embodiment 1000, where air pressure and air flow are used to enhance filtration in the hybrid brewing apparatus embodiment 3000, the valve linkage assembly 2000 acts as a fail-safe mechanism to control the opening and closing of the upper air plug valve 1340 and the lower water plug valve 1350. The solenoid mechanism 2150 drives the vertical transfer arm 2100 up and down. The upper arm 2200 hingedly connects to an upper end of the vertical transfer arm 2100. A lower valve arm 2300 hingedly connects with a bottom end of the vertical transfer arm 2100.

The upper arm 2200 of the linkage assembly 2000 is mounted on an upper pivot point 2206. An end 2204 of the upper arm 2200 raises and lowers the upper air plug valve 1340 based on the actuation of the solenoid mechanism 2150 and motion of the vertical transfer arm 2100. An end 2310 of the lower arm 2300 raises and lowers a dispensing valve plug 1350 based on the actuation of the solenoid mechanism 2150 and motion of the vertical transfer arm 2100.

In a hybrid configuration, using both air pressure and vibratory action to enhance the filtration process, the linkage assembly 2000 ensures that the lower dispensing water valve plug 1350 is open and that the upper air release valve plug 1340 is closed when air pressure has been applied to accelerate filtration. Where only a vibratory process is used to enhance the filtration process, the upper valve plug 1340 may remain open by virtue of a bypass hinge that disconnects the operation of the top rocker transfer arm 2204 from the vertical transfer arm 2100.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing a French press according to the inventive subject matter, emphasizing the application of vibratory energy, will be apparent to those skilled in the art. For example, the apparatus and method described herein may include features and functionality that automate the brewing process. Various aspects of the invention have been described above by way of illustration, and the specific embodiments disclosed are not intended to limit the invention to the forms disclosed. The implementation of the French press apparatus may vary depending upon the context or application. The invention is thus to cover all modifications, equivalents and alternatives falling within the spirit and scope of the following claims. It is to be further understood that not all the disclosed embodiments in the foregoing specification will necessarily satisfy or achieve each of the objects, advantages, or improvements described in the foregoing specification. Claim elements and steps herein may have been numbered and/or lettered solely as an aid in readability and understanding. Any such numbering and lettering is not intended to and should not be taken to indicate the ordering of elements and/or steps in the claims.

The corresponding structures, materials, acts and equivalents of all means or step plus function elements in the claims below are intended to include any structure, material, or act for performing the function in combination with other claimed elements as specifically claimed. The Abstract is provided to allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A brewing apparatus for producing French press style coffee comprising:
a. an immersion chamber for receiving a beverage element and brewing liquid;
b. a microperforated filter for filtering a spent beverage element from a brewed mixture upon completion of brewing; and,
c. means for accelerating filtration of the brewed beverage.

2. The apparatus of claim 1 wherein said means for accelerating filtration comprises vibratory action, air-centric action, and combined vibratory/air-centric action.

3. The apparatus of claim 2 wherein said means for accelerating filtration comprises vibratory action create by one or more vibratory elements and said vibratory elements configured to create standing waves within the brew mixture while dispensing, said standing waves causing coffee grounds and sediment to aggregate in a center portion of the brew mixture while dispensing, thereby minimizing the amount of sediment transported into the finished beverage.

4. The apparatus of claim 1 wherein said immersion chamber and said microperforated filter are conically-shaped and basket-shaped.

5. The apparatus of claim 1 wherein said microperforated filter is disc-shaped.

6. The apparatus of claim 1 where said immersion chamber includes one or more spacers and a sealing ring to enhance air-centric filtration.

7. The apparatus of claim 1 wherein said immersion chamber has a smooth interior surface.

8. The apparatus of claim 1 further including a valve linkage assembly, said valve linkage assembly comprising:
a. a lever frame positioned centrally within a housing of said apparatus to support said valve linkage assembly;
b. a vertical transfer arm slidably seated within said lever frame;
c. an electric solenoid connected with said vertical transfer arm;
d. said electric solenoid actuating to move said vertical transfer arm between a top position and a lower position;
e. said vertical transfer arm actuating a lower arm;
f said lower arm actuating a lower water plug valve;
g. said vertical transfer arm actuating an upper arm; said upper arm comprising a top rocker litter arm and a top rocker transfer arm; and,
h. said upper arm actuating an upper air plug valve.

9. The apparatus of claim 7 wherein said valve linkage assembly is operable to support a steeping mode and a dispensing mode wherein:
a. in a steeping mode, the vertical transfer arm is in an upper position and said lower water plug valve is closed and said upper air plug valve is open; and,
b. in a dispensing mode, said vertical transfer arm is in a lower position and said lower water plug valve is open and said upper air plug valve is closed.

10. The apparatus of claim 1 further comprising a dual-purpose pump to pump heated water into said immersion chamber and to pump air into said immersion chamber during filtering and dispensing of a finished beverage from said immersion chamber.

11. The apparatus of claim 1 further including sensors for monitoring operational parameters of said apparatus while brewing, said sensors selected from the group of gas sensors, liquid level sensors, pressure sensors, flow sensors, temperature sensors, valve position sensors, infrared sensors, and visual sensors.

12. The apparatus of claim 11 wherein a control unit causes said vibratory elements to terminate vibratory action when fluid level within said immersion chamber drops below the level of the placement of each of said vibratory elements during filtration.

13. A brewing method comprising the steps of:
a. combining a beverage element and heated water;
b. allowing the mixture of the beverage element and heated water to steep for a specified time;
c. filtering said brewed mixture through microperforations in a microperforated filter with gravity enhanced by any combination of vibration, air pressure, and air flow.

14. The brewing method of claim 13 further including the steps of:
a. said heated water is manually boiled;
b. said steeping time is tracked manually; and,
c. said filtration of the brewed beverage through said filter is manually initiated by means of a switch.

15. The brewing method of claim 13 further including the steps of:
a. automatically heating water in a water heating vessel;
b. automatically transferring heated water via a water pump to said immersion chamber;
c. automatically tracking immersion duration via an automated time;
d. automatically operating a dispensing valve, one or more air pumps and one more vibratory elements, wherein said one or more air pumps and said one or more vibratory elements accelerate filtration.

16. The brewing method of claim 15 further including the steps of initiating bloom dissipation vibratory action and fresh air sweep prior to filtration.

17. A microperforated filter for filtering a coffee brew mixture to produce French press style coffee, wherein a plurality of microperforations minimize sediment transported from the brewed mixture to the finished beverage and the material of said microperforated filter minimizes absorption of coffee oils and lipids.

18. The filter of claim 10 wherein said microperforations are circular having diameters in the range of 50 microns to 250 microns.

19. The filter of claim 10 wherein said micro-perforations are distributed in a density range of between 10 perforations per square inch and 700 perforations per square inch.

20. The filter of claim 17 wherein said filter is prepackaged to include coffee grounds for use as a single-use pouch.
